(19) United States
(12) Patent Application Publication
(10) Pub. No.: US 2025/0022309 A1
(43) Pub. Date: Jan. 16, 2025

(54) PALM IMAGE PROCESSING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Weiming YANG, Shenzhen (CN); Runzeng GUO, Shenzhen (CN); Shaoming WANG, Shenzhen (CN); Jinkun HOU, Shenzhen (CN); Jun WANG, Shenzhen (CN)

(21) Appl. No.: 18/898,401

(22) Filed: Sep. 26, 2024

Related U.S. Application Data
(63) Continuation of application No. PCT/CN2023/118472, filed on Sep. 13, 2023.

(30) Foreign Application Priority Data
Nov. 21, 2022 (CN) 202211473335.6

(51) Int. Cl. G06V 40/12; G06F 21/32; G06T 3/40; G06T 7/11; G06V 10/80

(52) U.S. Cl. CPC G06V 40/1365; G06F 21/32; G06T 3/40; G06T 7/11; G06V 10/806; G06V 40/1347; G06T 2207/10048; G06T 2207/20132

(57) ABSTRACT

A palm image processing method is performed by a computer device. The method includes: obtaining a palm image, and performing feature extraction on the palm image, to obtain image features at a plurality of scales; fusing the image features at the plurality of scales, to obtain an image fusion feature; determining, based on the image fusion feature, a palm part frame identifying a palm part in the palm image as a palm part image; performing image encryption on the palm part image, to obtain encrypted palm part image data; and transmitting the encrypted palm part image data to a server, and the server performing identity recognition based on the encrypted palm part image data.

### CROSS-REFERENCE TO RELATED APPLICATIONS

This application is a continuation application of PCT Patent Application No. PCT/CN2023/118472, entitled “PALM IMAGE PROCESSING METHOD AND APPARATUS, DEVICE, STORAGE MEDIUM, AND PROGRAM PRODUCT” filed on Sep. 13, 2023, which claims priority to Chinese Patent Application No. 2022114733356, entitled “PALM IMAGE PROCESSING METHOD AND APPARATUS, DEVICE, STORAGE MEDIUM, AND PROGRAM PRODUCT” filed on Nov. 21, 2022, both of which are incorporated herein by reference in their entirety.

### FIELD OF THE TECHNOLOGY

Embodiments of this application relate to the field of computer technologies, further to the field of computer vision technologies, and in particular, to a palm image processing method and apparatus, a device, a storage medium, and a program product.

### BACKGROUND OF THE DISCLOSURE

With the development of computer technologies, a palm recognition technology is increasingly widely applied, and may be applied to a plurality of scenarios. For example, in a payment scenario or a check in scenario at work, verification may be performed on a user identity through palm recognition.

In the related art, a user provides a physical palm, and a palm recognition device collects a palm image on the palm part of the user, so that the palm recognition device performs encryption on the palm image based on the palm image, and the encrypted palm image is configured for identity verification.

However, performing encryption and decryption on the palm image requires a large amount of time, which reduces efficiency of palm recognition.

### SUMMARY

According to various embodiments of this application, a palm image processing method and apparatus, a device, a storage medium, and a program product are provided.

According to an aspect, a palm image processing method is performed by a computer device, including:
obtaining a palm image, and performing feature extraction on the palm image, to obtain image features at a plurality of scales;
fusing the image features at the plurality of scales, to obtain an image fusion feature;
determining, based on the image fusion feature, a frame identifying a palm part in the palm image as a palm part image;
performing image encryption on the palm part image, to obtain encrypted palm part image data; and
transmitting the encrypted palm part image data to a server, and the server performing identity recognition based on the encrypted palm part image data.

According to another aspect, a method for training a palm part detection model is provided, performed by a computer device, the method including:
obtaining a sample palm image and a sample palm part image;
performing feature extraction on the sample palm image, to obtain sample image features at a plurality of scales;
fusing the sample image features at the plurality of scales, to obtain a sample image fusion feature;
determining, based on the sample image fusion feature, a sample prediction palm part frame identifying a palm part in the sample palm image as a palm part image;
cropping out a sample prediction palm part image from the sample palm image based on the sample prediction palm part frame;
calculating a loss function value according to the sample palm part image and the sample prediction palm part image; and
updating a model parameter of the palm part detection model based on the loss function value.

According to another aspect, this application further provides a computer device, including a memory and a processor, the memory having computer-readable instructions stored therein, the computer-readable instructions, when executed by the processor, causing the computer device to implement the operations of the method embodiments in this application.

According to another aspect, this application further provides a non-transitory computer-readable storage medium, having computer-readable instructions stored therein, the computer-readable instructions, when executed by a processor of a computer device, causing the computer device to implement the operations of the method embodiments in this application.

Details of one or more embodiments of this application are provided in the subsequent accompanying drawings and descriptions. Other features, objectives, and advantages of this application become apparent from the specification, the accompanying drawings, and the claims.

### BRIEF DESCRIPTION OF THE DRAWINGS

To describe the technical solutions in embodiments of this application more clearly, the following briefly introduces the accompanying drawings required for describing the embodiments. Apparently, the accompanying drawings in the following description show only some embodiments of this application, and a person of ordinary skill in the art may still derive other accompanying drawings from the accompanying drawings without creative efforts.

FIG. 1 is a schematic diagram of a palm image processing method according to an exemplary embodiment of this application.

FIG. 2 is a schematic diagram of an architecture of a computer system according to an exemplary embodiment of this application.

FIG. 3 is a flowchart of a palm image processing method according to an exemplary embodiment of this application.

FIG. 4 is a flowchart of a palm image processing method according to an exemplary embodiment of this application.

FIG. 5 is a schematic diagram of image feature fusion according to an exemplary embodiment of this application.

FIG. 6 is a schematic diagram of finger gap points in a palm according to an exemplary embodiment of this application.

FIG. 7 is a schematic diagram of a palm image processing method according to an exemplary embodiment of this application.

FIG. 8 is a schematic flowchart of a palm image processing method applied to a cross-device payment scenario according to an exemplary embodiment of this application.

FIG. 9 is a schematic flowchart of a palm image processing method applied to a cross-device identity verification scenario according to an exemplary embodiment of this application.

FIG. 10 is a schematic flowchart of a palm image processing method according to an exemplary embodiment of this application.

FIG. 11 is a framework diagram of a generation phase of a palm part detection model and a prediction phase of a palm part frame according to an exemplary embodiment of this application.

FIG. 12 is a flowchart of a method for training a palm part detection model according to an exemplary embodiment of this application.

FIG. 13 is a flowchart of a method for training a palm part detection model according to an exemplary embodiment of this application.

FIG. 14 is a block diagram of a palm image processing apparatus according to an exemplary embodiment of this application.

FIG. 15 is a block diagram of an apparatus for training a palm part detection model according to an exemplary embodiment of this application.

FIG. 16 is a schematic diagram of a structure of a computer device according to an exemplary embodiment of this application.

### DESCRIPTION OF EMBODIMENTS

The technical solutions in embodiments of this application are clearly and completely described in the following with reference to the accompanying drawings in embodiments of this application. Apparently, the described embodiments are merely some rather than all of embodiments of this application. All other embodiments obtained by a person of ordinary skill in the art based on embodiments of this application without creative efforts shall fall within the protection scope of this application.

A computer vision (CV) technology is a science that studies how to use a machine to “see”, and furthermore, is machine vision that a camera and a computer are used for replacing human eyes to perform recognition, measurement, and the like on a target, and further perform graphic processing, so that the computer processes the target into an image more suitable for human eyes to observe, or an image transmitted to an instrument for detection. As a scientific discipline, the computer vision studies related theories and technologies and attempts to establish an artificial palm image recognition system that can obtain information from images or multidimensional data. The computer vision technologies generally include technologies such as image processing, image recognition, image semantic understanding, image retrieval, video processing, video semantic understanding, video content/behavior recognition, three-dimensional object reconstruction, a 3D technology, virtual reality, augmented reality, synchronous positioning, and map construction, and further include common biometric feature recognition technologies.

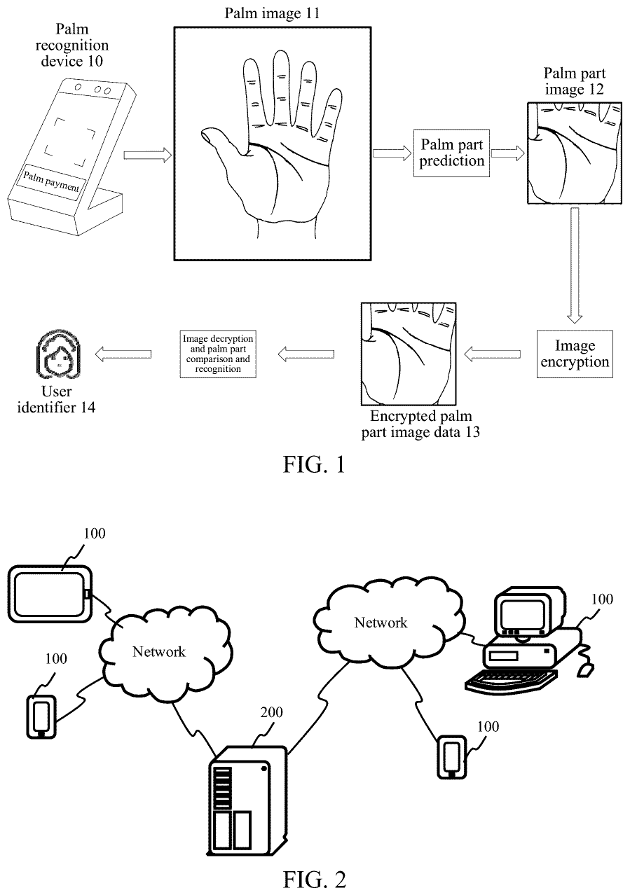

An embodiment of this application provides a schematic diagram of a palm image processing method. As shown in FIG. 1, the method may be performed by a palm recognition device 10. The palm recognition device 10 may have an image encryption function.

For example, the palm recognition device 10 includes a camera, and the palm recognition device 10 obtains a palm image 11 through a camera. The palm recognition device 10 may also be connected to an image collector. The image collector includes a camera. The palm recognition device 10 may obtain the palm image 11 collected by the image collector. The palm recognition device 10 performs palm part prediction on the palm image 11, to obtain a palm part image 12 corresponding to a palm part in the palm image 11. The palm recognition device 10 performs image encryption on the palm part image 12, to obtain encrypted palm part image data 13. The palm recognition device 10 transmits the encrypted palm part image data 13 to a palm recognition server for decryption and palm part comparison and recognition, to obtain a user identifier 14 corresponding to the palm image 11.

For example, the palm recognition device 10 obtains the palm image 11, and performs feature extraction on the palm image 11, to obtain image features at a plurality of scales. The palm recognition device 10 performs feature fusion on the image features at the plurality of scales, to obtain an image fusion feature. The palm recognition device 10 determines a palm part frame in the palm image 11 based on the image fusion feature. The palm recognition device 10 crops out a palm part image 12 from the palm image 11 based on the palm part frame. The palm recognition device 10 performs image encryption on the palm part image 12, to obtain the encrypted palm part image data 13.

The encrypted palm part image data 13 is configured for being transmitted to the palm recognition server for decryption and palm part comparison and recognition, to obtain the user identifier 14 corresponding to the palm image 11.

The palm part image 12 is an effective recognition area in the palm image 11, or the palm part image 12 is an area in the palm image 11 in which the palm part is located, or the palm part image 12 is an area in the palm image 11 that can be configured for palm recognition.

In some embodiments, manners in which the palm recognition device 10 transmits the encrypted palm part image data 13 to the palm recognition server include at least one of network transmission, data line transmission, and Bluetooth transmission, but is not limited thereto. This is not specifically limited in the embodiments of this application.

For example, the palm recognition device 10 performs feature extraction on the palm image 11, to obtain the image features. The palm recognition device 10 performs feature fusion on the image features, to obtain the image fusion feature. The palm recognition device 10 determines the palm part frame in the palm image, and crops out the palm part image 12 from the palm image based on the palm part frame.

For example, the palm part frame can be obtained by prediction by the palm part detection model, and the palm part detection model includes a backbone network, a neck network, and a prediction network.

The palm recognition device 10 inputs the palm image 11 into the backbone network; the backbone network performs a slicing operation on the palm image, to obtain slice images at the plurality of scales; and the palm recognition device 10 performs feature extraction on the slice images at the plurality of scales, to obtain the image features at the plurality of scales corresponding to the palm image 11. The scale represents a size of a feature, and the plurality of scales refer to a plurality of sizes.

For example, a size of the input palm image 11 is 640*640, and sizes of the output image features at the plurality of scales are: 80*80, 40*40, and 20*20. A scale or a size of an image or a feature may be a dimension of a matrix representing the image or the feature.

For example, the palm recognition device 10 inputs the image features at the plurality of scales into the neck network for feature fusion, to obtain the image fusion feature. The palm recognition device 10 inputs the image fusion feature into the prediction network for prediction, to obtain the palm part frame in the palm image 11. The palm recognition device 10 crops an image area outside the palm part frame in the palm image 11 and uses a remaining image as the palm part image 12.

In summary, according to the method provided in this embodiment, the image features at the plurality of scales corresponding to the palm image are obtained by obtaining the palm image and performing feature extraction; feature fusion is performed on the image features at the plurality of scales, to obtain the image fusion feature; a palm part frame corresponding to a palm part in the palm image is determined based on the image fusion feature; the palm part image corresponding to the palm part is obtained by cropping the palm image based on the palm part frame; and image encryption is performed on the palm part image, to obtain the encrypted palm part image data, and the encrypted palm part image data is transmitted to the palm recognition server for decryption and palm part comparison and recognition, to perform identity recognition. In this application, the palm part image corresponding to the palm part is obtained by cropping the palm image, and image encryption, transmission, and decryption are performed only on the palm part image. This reduces time of recognizing the palm image and improves recognition efficiency of palm recognition.

FIG. 2 is a schematic diagram of an architecture of a computer system according to an embodiment of this application. The computer system may include: a palm recognition device 100 and a palm recognition server 200.

The palm recognition device 100 may be an electronic device such as a mobile phone, a tablet computer, a vehicle-mounted terminal (vehicle), a wearable device, a personal computer (PC), a voice interaction device with a palm image recognition function, an appliance with a palm image recognition function, a vehicle-mounted terminal, an aircraft, or a vending terminal. A client running an application may be installed in the palm recognition device 100. The application may be an application specifically performing palm image recognition, or another application providing a palm image recognition function. This is not limited in this application. In addition, a form of the application is not limited in this application, including but not limited to an application (App), a sub-application, a web page program, and the like installed in the palm recognition device 100. The sub-application is a program running in a running environment provided by a parent application program. The parent application program is an independent native application. The child application runs in dependence on the parent application.

The palm recognition server 200 may be an independent physical server, or may be a server cluster including a plurality of physical servers or a distributed system, or may be a cloud server providing basic cloud computing services, such as a cloud server providing cloud computing services, a cloud database, cloud computing, a cloud function, cloud storage, a network service, cloud communication, a middleware service, a domain name service, a security service, a content delivery network (CDN), big data, and an artificial palm image recognition platform. The palm recognition server 200 may be a backend server of the foregoing application, and is configured to provide a backend service for a client of the application.

The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A backend service of a technical network system requires a large amount of computing and storage resources, such as video websites, image websites, and more portal websites. As the internet industry is highly developed and applied, each article may have its own identifier in the future and needs to be transmitted to a backend system for logical processing. Data at different levels is separately processed, and data in various industries requires strong system support, which can only be implemented through cloud computing.

In some embodiments, the server may be further implemented as a node in a blockchain system. A blockchain is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, the information being used for verifying the validity of information of the data block (anti-counterfeiting) and generating a next block. The blockchain may include an underlying blockchain platform, a platform product service layer, and an application service layer.

The palm recognition device 100 and the palm recognition server 200 may communicate through a network, such as a wired network or a wireless network.

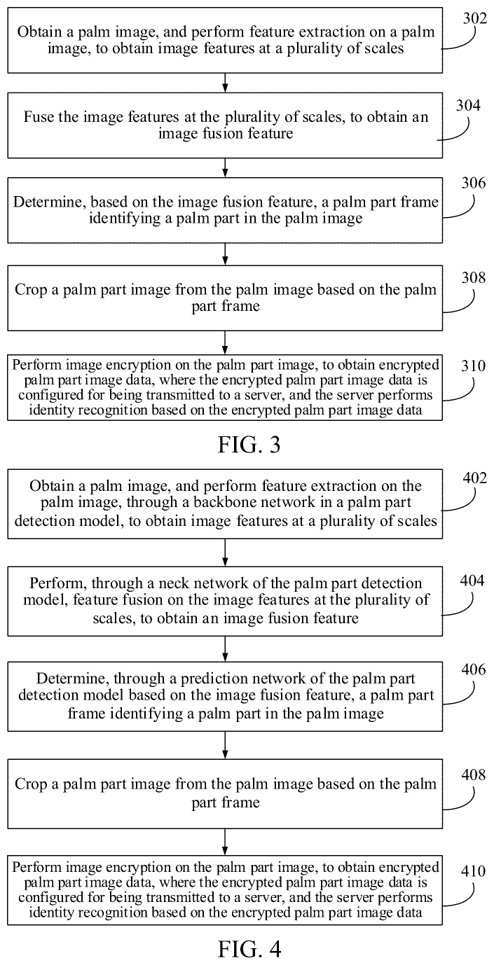

FIG. 3 is a flowchart of a palm image processing method according to an exemplary embodiment of this application. The method is performed by a palm recognition device. The method may also be performed by a server. The method includes the following operations.

Operation 302: Obtain a palm image, and perform feature extraction on the palm image, to obtain image features at a plurality of scales.

The palm image is an image obtained by capturing a physical palm. The physical palm includes a palm part and fingers. The palm part is an organism connecting a physical arm and physical fingers. The palm image includes an image of all or a part of the physical palm. For ease of description, an image of the physical palm in the palm image is referred to as a palm subsequently. The palm included in the palm image may be a physical palm of a user whose identity recognition is to be performed. The palm in the palm image includes at least a palm part, may further include the fingers or a part of the arm, and may further include an image of an environment in which the physical palm is located when the physical palm is captured.

A scale is a size of an image feature, and may be represented by a matrix dimension number, such as 100*100, 80*80, 60*60, or 40*40. The plurality of scales refer to two or more scales, and each scale is different. A maximum scale in the plurality of scales may be the same as a scale of the palm image, and is generally smaller than the scale of the palm image.

The palm image may be obtained by capturing, by the palm recognition device, a physical palm of a user whose identity is to be verified, or may be transmitted by another device. The palm recognition device may directly collect an image of the physical palm, to obtain the palm image. The palm recognition device may also collect the image of the physical palm through an image collector connected to the palm image, to obtain the palm image. The palm recognition device can perform feature extraction on the obtained palm image, to obtain image features at a plurality of scales corresponding to the palm image.

For example, the palm recognition device is a cash register device in a store, and the cash register device in the store captures a physical palm of a user through a camera, to obtain the palm image. Alternatively, the palm recognition device is a palm image recognition server, and after capturing a palm image of a user, a cash register device in a store transmits the palm image to the palm image recognition server.

For example, the image features at the plurality of scales may be respectively extracted from low-resolution images at the plurality of scales by downsampling a high-resolution palm image into the low-resolution images at the plurality of scales. The high resolution and the low resolution are relative concepts, and the high resolution is a resolution higher than the low resolution.

For example, a size of the input palm image is 640*640, and sizes of the output image features at the plurality of scales are: 80*80, 40*40, and 20*20.

Operation 304: Fuse the image features at the plurality of scales, to obtain an image fusion feature.

The palm recognition device may perform feature fusion on the image features at the plurality of scales, to obtain the image fusion feature.

The image features at the plurality of scales refer to features obtained by performing feature extraction on images at the plurality of scales. Image features at different scales may express different information. In the image features at the plurality of scales, image features at larger scales express more position information, and image features at smaller scales express more semantic information.

For example, the palm recognition device extracts features at the plurality of scales, under different receptive fields, and in different categories, and fuses the image features at the plurality of scales, to obtain the image fusion feature corresponding to the palm image.

Operation 306: Determine, based on the image fusion feature, a palm part frame identifying a palm part in the palm image.

The palm part frame is an identifier configured for representing a position of the palm part in the palm image. The palm part frame includes the palm part in the palm image. A boundary of the palm part frame encloses the palm part in the palm image.

In some embodiments, a shape of the palm part frame may be a regular shape, for example, may be at least one of a rectangle, a square, a rhombus, a hexagon, a circle, or a triangle. The shape of the palm part frame may alternatively be an irregular shape. The regular shape is a shape that can be drawn by using a fixed parameter and based on a fixed rule. The irregular shape cannot be drawn by using the fixed parameter and based on the fixed rule, and can generally only be represented by a set of points that constitute the irregular shape.

The palm recognition device can perform prediction based on the image fusion feature by using artificial intelligence, to determine the palm part frame corresponding to the palm part in the palm image.

In some embodiments, a computer device can determine, based on the image fusion feature, the position of the palm part frame in the palm image that identifies the palm part in the palm image. When the palm part frame is of the regular shape, the position may be represented by a value of the fixed parameter required for drawing the regular shape, for example, may be represented by a position of a fixed point of the palm part frame and a size parameter of the palm part frame. The fixed point is a point whose position is fixed relative to the palm part frame. The size parameter is a parameter representing a size of the palm part frame. For example, when the palm part frame is of the rectangle shape, the fixed point may be any corner point or a center point of the rectangle, and the size parameter is a side length of an adjacent side of the palm part frame.

Operation 308: Crop out a palm part image from the palm image based on the palm part frame.

The palm part image is an effective recognition area in the palm image, or the palm part image is an area in the palm image in which the palm part is located, or the palm part image is an area in the palm image that can be configured for palm recognition.

For example, the palm recognition device crops, based on the position of the palm part frame, an image area located outside the palm part frame in the palm image, and uses a remaining image as the palm part image.

Operation 310: Perform image encryption on the palm part image, to obtain encrypted palm part image data, where the encrypted palm part image data is configured for being transmitted to a server, and the server performing identity recognition based on the encrypted palm part image data.

The encrypted palm part image data is data obtained by encrypting the palm part image. The palm part image can be obtained by decrypting the encrypted palm part image data. The encrypted palm part image data may be a bit stream or a word string, or may be an image with content that is difficult to identify by naked eyes. The palm part image is configured for being transmitted to a server, and the server performs identity recognition based on the encrypted palm part image data.

The palm recognition device may access a network and transmit the encrypted palm part image data to the server through the network. The palm recognition device may also transmit the encrypted palm part image data to a terminal through a point-to-point connection between the palm recognition device and the terminal, and then the terminal accessing the network transmits the encrypted palm part image data to the server. When the palm recognition device is the server, the encrypted palm part image data may be transmitted to another server through a direct cable or the network.

In some embodiments, the server may decrypt the encrypted palm part image data, to obtain the palm part image, and then perform identity recognition based on the palm part image obtained by decryption.

In some embodiments, the server may decrypt the encrypted palm part image data, to obtain the palm part image, and search a database for a palm part image matching the palm part image obtained by decryption. When the matching palm part image is found, a user identifier associated with the matching palm part image is determined, to perform identity recognition. When no matching palm part image is found, it may be determined that identity recognition fails.

In some embodiments, the server may decrypt the encrypted palm part image data, to obtain the palm part image, extract a palm part feature from the palm part image, and then search the database for a palm part feature matching the extracted palm part feature. When the matching palm part feature is found, the user identifier associated with the matching palm part feature is determined, to perform identity recognition.

In some embodiments, after determining the user identifier by performing identity recognition based on the encrypted palm part image data, the server can further verify a permission corresponding to the user identifier. When verifying that the user identifier has a permission for a preset function, the server may further execute or trigger the preset function. The preset function is, for example, access control or another function that needs to verify a user permission.

In some embodiments, manners in which the palm recognition device transmits the encrypted palm part image data to the palm recognition server include at least one of network transmission, data line transmission, and Bluetooth transmission, but is not limited thereto. This is not specifically limited in embodiments of this application.

The palm recognition device may perform decryption and palm part comparison and recognition based on the encrypted palm part image data, to perform identity recognition. The palm part comparison and recognition may be specifically comparing and recognizing the palm part feature in the palm part image with a preset palm part feature in the database.

The preset palm part feature is a palm part feature of a palm part of a stored user identifier, and each preset palm part feature has a corresponding user identifier, representing that the preset palm part feature belongs to the user identifier and is the palm part feature of the palm part of the user. The user identifier may be any user identifier. For example, the user identifier is a user identifier registered in a payment application, or the user identifier is a user identifier registered in an enterprise.

In this embodiment of this application, the palm recognition server includes the database. The database includes a plurality of preset palm part features and the user identifier corresponding to each preset palm part feature. In the database, the preset palm part features and the user identifiers may be in a one-to-one correspondence, or one user identifier may correspond to at least two preset palm part features.

For example, a plurality of users register in the payment application, a preset palm part feature of each user is bound with a corresponding user identifier, and the palm part features of the plurality of users and the corresponding user identifiers are correspondingly stored in the database. Subsequently, when the user uses the payment application, a target user identifier is determined by performing palm part comparison and recognition on a first palm part area of an infrared image and a second palm part area of a color image and the preset palm part features in the database, to implement identity verification on the user.

For example, the palm recognition device transmits the encrypted palm part image data to a palm recognition server for decryption and palm part comparison and recognition, to obtain a user identifier corresponding to the palm image.

In summary, according to the method provided in this embodiment, the image features at the plurality of scales corresponding to the palm image are obtained by obtaining the palm image and performing feature extraction; feature fusion is performed on the image features at the plurality of scales, to obtain the image fusion feature; prediction is performed based on the image fusion feature, to obtain the palm part frame corresponding to the palm part in the palm image; the palm part image corresponding to the palm part is obtained by cropping the palm image based on the palm part frame; and image encryption is performed on the palm part image, to obtain the encrypted palm part image data, and the encrypted palm part image data is transmitted to the palm recognition server for decryption and palm part comparison and recognition, to obtain a user identifier corresponding to the palm image. In this application, the palm part image corresponding to the palm part is obtained by cropping the palm image, and image encryption, transmission, and decryption are performed only on the palm part image. This reduces time of recognizing the palm image and improves recognition efficiency of palm recognition.

FIG. 4 is a flowchart of a palm image processing method according to an exemplary embodiment of this application. The method is performed by a palm recognition device. The method includes the following operations.

Operation 402: Obtain a palm image, and perform feature extraction on the palm image, through a backbone network in a palm part detection model, to obtain image features at a plurality of scales.

The palm image is a palm image of a to-be-determined user identifier.

For example, the palm recognition device captures a physical palm of the user, to obtain the palm image. The palm image includes the palm. The palm may be a left palm of the user or a right palm of the user.

For example, the palm recognition device is an internet of things device. The internet of things device captures the left palm of the user through a camera, to obtain the palm image. The internet of things device may be a cash register device in a store. For another example, when the user shops for a transaction in the store, the user extends a palm toward a camera of a payment terminal in the store, and the payment terminal in the store captures the physical palm of the user through the camera, to obtain the palm image.

In some embodiments, the palm recognition device establishes a communication connection with another device, and receives, through the communication connection, a palm image transmitted by the another device. For example, the palm recognition device is a payment application server, and the another device may be a payment terminal. After the payment terminal captures the physical palm of the user, to obtain the palm image, the palm image is transmitted to the payment application server through the communication connection between the payment terminal and the payment application server, so that the payment application server can determine a user identifier of the palm image.

In some embodiments, the palm part frame is obtained by prediction by a palm part detection model, and the palm part detection model includes a backbone network; and the performing feature extraction on the palm image, to obtain image features at a plurality of scales includes: performing a slicing operation on the palm image through the backbone network, to obtain slice images at the plurality of scales; and respectively performing feature extraction on the slice images at the plurality of scales through the backbone network, to obtain the image features at the plurality of scales.

The palm part detection model is an artificial intelligence model, may be a deep learning model, or may be a neural network model. The palm part detection model has at least a function of determining, based on an image fusion feature, a palm part frame identifying a palm part in the palm image. The backbone network is a structure configured for extracting image features at a plurality of scales from the palm image in the palm part detection model. The slicing operation is an operation of segmenting the palm image to generate images at smaller scales. The smaller scale means that a scale of the generated image is smaller than the scale of the palm image. Pixels in the slice image are derived from the palm image.

The palm recognition device may perform a slicing operation through the backbone network, to obtain the slice images at the plurality of scales. The palm recognition device may perform feature extraction on the slice images at the plurality of scales, to obtain the image features at the plurality of scales corresponding to the palm image.

In some embodiments, the performing a slicing operation on the palm image through the backbone network, to obtain slice images at the plurality of scales includes: determining, through the backbone network and based on the palm image, a slice image at a maximum scale in the plurality of scales; and using, through the backbone network, the slice image at the maximum scale as a first layer, and starting downsampling layer by layer, to obtain the slice images at the plurality of scales including the slice image at the first layer.

A computer device may first determine, based on the palm image, the slice image at the maximum scale in the plurality of scales. The scale of the image feature at the maximum scale may be smaller than or equal to the scale of the palm image. The computer device may downsample the palm image once, to generate the slice image at the maximum scale in the plurality of scales.

Downsampling the palm image is a process of sampling at least one pixel in the palm image. Pixels obtained through downsampling are spliced in sequence in the palm image, so that a slice image at a smaller scale can be obtained.

If a quantity of the plurality of scales is N, the plurality of scales are N scales. The N scales are all different scales, and therefore, there is a maximum scale in the N scales. The slice image at the maximum scale is used as a first layer, downsampling layer by layer is started from the first layer, an n^{th} layer is downsampled to obtain a slice image at an (n+1)^{th} layer, and an (N−1)^{th} layer is downsampled to obtain a slice image at the N^{th} layer. n is a positive integer from 1 to N−1. Finally, a total of N slice images at the first layer to the N^{th} layer may be obtained.

In this embodiment, the slice images at the plurality of scales are obtained by downsampling layer by layer, which provides a new way to obtain the slice images at the plurality of scales by segmenting the palm image.

In some embodiments, the performing a slicing operation on the palm image through the backbone network, to obtain slice images at the plurality of scales includes: downsampling and splicing, through the backbone network, pixels in the palm image at the plurality of scales, to obtain the slice images at the plurality of scales. There are two adjacent pixels in slice images at different scales, and a quantity of pixels between the two pixels at which sampling occurs in the palm image is different.

In this embodiment, the palm recognition device may sample the pixels from the palm image at each scale by using a sampling interval at the scale, and splice the sampled pixels according to a relative position relationship in the palm image, to obtain a slice image at each scale. The sampling interval is a quantity of pixels that are spaced, including intervals of pixels in two directions: a row and a column. The scale is negatively correlated with the sampling interval. A larger scale indicates a smaller sampling interval. A smaller scale indicates a larger sampling interval. Pixels that are not sampled in the palm image may be concentrated to a channel of an image feature.

For example, at a maximum scale in the plurality of scales, in the palm image, sampling is performed on every other column. That is, a pixel is selected every other pixel in the row direction, and the selected pixels are spliced, to obtain the slice image. Information in the spliced slice image is not lost, but size information in the palm image is concentrated on the channel, and a convolution operation is performed on an obtained new image, to obtain a downsampling feature map without information loss.

For another example, at a second largest scale in the plurality of scales, in the palm image, sampling is performed in every two columns. That is, pixels are selected every two pixels, and the selected pixels are spliced, to obtain the slice image. Information in the spliced slice image is not lost, but size information in the palm image is concentrated on the channel, and a convolution operation is performed on an obtained new image, to obtain a downsampling feature map without information loss.

For example, a size of an original image is: 640*640*3. Through the slicing operation, a feature map of 320*320*12 is obtained. 640*640 in the original image is configured for representing width*height, and 3 in the original image is configured for representing a length (also referred to as a quantity of channels) of a feature vector corresponding to each pixel.

Operation 404: Perform, through a neck network of the palm part detection model, feature fusion on the image features at the plurality of scales, to obtain the image fusion feature.

The palm part frame is obtained by prediction by the palm part detection model, and the palm part detection model includes a neck network; and the fusing the image features at the plurality of scales, to obtain an image fusion feature includes: performing, through the neck network, feature fusion on the image features at the plurality of scales, to obtain the image fusion feature.

The neck network belongs to the palm part detection model and is a structure configured for performing feature fusion on the image features at the plurality of scales to obtain the image fusion feature. The neck network is connected to the backbone network, and is configured for receiving the image features at the plurality of scales output by the backbone network.

The image features at the plurality of scales refer to features obtained by performing feature extraction on images at the plurality of scales. Image features at different scales may express different information. In the image features at the plurality of scales, image features at larger scales express more position information, and image features at smaller scales express more semantic information.

For example, the palm recognition device extracts features at the plurality of scales, under different receptive fields, and in different categories, and fuses the image features at the plurality of scales, to obtain the image fusion feature corresponding to the palm image.

In some embodiments, the performing, through the neck network, feature fusion on the image features at the plurality of scales, to obtain the image fusion feature includes: performing, through the neck network, fusion at the same scale on the image features at the plurality of scales, to obtain the image fusion feature. The fusion of the image features at the same scale may be summation or averaging.

The palm recognition device fuses the image features at the plurality of scales, which increases detection accuracy of a small target, so that a palm part frame can be detected more accurately. In this way, the palm part image can be cropped out more accurately. This further reduces a data amount of the encrypted palm part image data, improves identity recognition efficiency, and ensures security of identity recognition.

In some embodiments, the performing, through the neck network, feature fusion on the image features at the plurality of scales, to obtain the image fusion feature includes: performing, through the neck network, feature fusion based on the image features at the plurality of scales, to obtain first intermediate features at the plurality of scales; performing, through the neck network, feature fusion at the plurality of scales based on the first intermediate features at the plurality of scales, to obtain second intermediate features at the plurality of scales; and performing, through the neck network, feature fusion on the second intermediate features at the plurality of scales, to obtain the image fusion feature.

The feature fusion at the plurality of scales refers to performing feature fusion at different scales respectively. The first intermediate features at the plurality of scales may be in a one-to-one correspondence with the image features at the plurality of scales. The first intermediate features at the plurality of scales may be in a one-to-one correspondence with the second intermediate features at the plurality of scales. The image features at the plurality of scales may be consistent with the first intermediate features at the plurality of scales. The first intermediate features at the plurality of scales may be consistent with the second intermediate features at the plurality of scales. The performing feature fusion on the second intermediate features at the plurality of scales may be fusing, at the same scale, the second intermediate features at the plurality of scales. The fusion may be summation or averaging.

In this embodiment, features at different scales are fused and are finally fused into the image fusion feature, which can fully express detailed features in the palm image, so that a palm part frame is detected more accurately. In this way, the palm part image can be cropped out more accurately. This further reduces a data amount of the encrypted palm part image data, improves identity recognition efficiency, and ensures security of identity recognition.

In some embodiments, the plurality of scales are N scales, N is a positive integer greater than 1, and the extracting, based on the image features at the plurality of scales, first intermediate features at the plurality of scales includes: determining, based on an image feature ranking first in a positive order of scale, a first intermediate feature ranking first in the positive order of scale; upsampling layer by layer starting from the first intermediate feature ranking first in the positive order of scale, and fusing a result of upsampling a first intermediate feature ranking n^{th} in the positive order of scale with an image feature ranking (n+1)^{th} in the positive order of scale, to obtain a first intermediate feature ranking (n+1)^{th} in the positive order of scale; and determining, when obtaining a first intermediate feature at an N^{th} layer, the first intermediate features at the plurality of scales from a first layer to the N^{th} layer. n is a positive integer from 1 to N−1; and the positive order of scale is in ascending order of scale.

The ascending order is referred to as the positive order, and the positive order of scale is in ascending order of scale. Upsampling is a process of increasing the scale. The upsampling may use a scale at a next layer as a target, and adjacent feature elements in a feature at each layer are interpolated, to obtain a feature at the next layer.

In some embodiments, the determining, based on an image feature ranking first in a positive order of scale, a first intermediate feature ranking first in the positive order of scale includes: performing at least one time of convolution on the image feature ranking first in the positive order of scale, to obtain the first intermediate feature ranking first in the positive order of scale. In addition to performing convolution, channel adjustment may be further performed. A quantity of channels of the first intermediate features that are obtained after the channel adjustment is performed may be consistent.

In some embodiments, a scale of a result of upsampling the first intermediate feature ranking n^{th} in the positive order of scale may be the same as a scale of an image feature ranking (n+1)^{th} in the positive order of scale. The result of upsampling the first intermediate feature ranking n^{th} in the positive order of scale and the image feature ranking (n+1)^{th} in the positive order of scale are fused, and the two may be spliced, or summation or averaging may be performed on the two at the same scale.

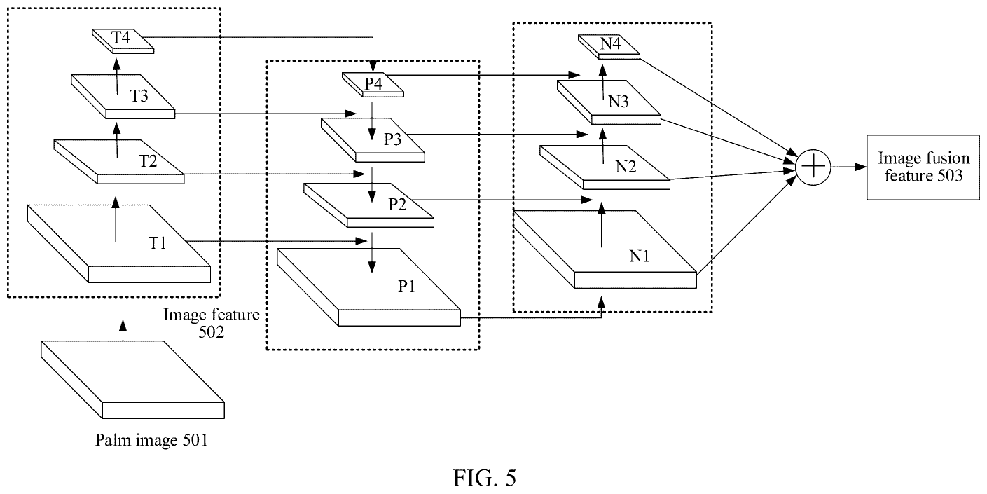

For example, FIG. 5 is a schematic diagram of image feature fusion. A palm recognition device performs feature extraction on a palm image 501, to obtain image features 502 at a plurality of scales corresponding to the palm image 501. The image features 502 include a feature layer T1, a feature layer T2, a feature layer T3, and a feature layer T4. After the image feature 502 is obtained, one time of convolution is performed on the feature layer T4 and channel adjustment is performed to obtain a feature layer P4. The feature layer P4 is upsampled and is combined with the feature layer T3, and then convolution is performed and channel adjustment is performed to obtain a feature layer P3. The feature layer P3 is upsampled and is combined with the feature layer T2, and then convolution is performed and channel adjustment is performed to obtain a feature layer P2. The feature layer P2 is upsampled and is combined with the feature layer T1, and then 1*1 convolution is performed and channel adjustment is performed to obtain a feature layer P1.

In some embodiments, the plurality of scales are N scales, N is a positive integer greater than 1, and the performing feature fusion at the plurality of scales based on the first intermediate features at the plurality of scales, to obtain second intermediate features at the plurality of scales includes: determining, based on a first intermediate feature ranking first in a reverse order of scale, a second intermediate feature ranking first in the reverse order of scale; downsampling layer by layer starting from the second intermediate feature ranking first in the reverse order of scale, and fusing a result of downsampling a second intermediate feature ranking m^{th} in the reverse order of scale with a first intermediate feature ranking (m+1)^{th} in the reverse order of scale, to obtain a second intermediate feature ranking (n+1)^{th} in the reverse order of scale, where m is an integer from 1 to N−1; and the reverse order of scale is in descending order of scale; and determining, when obtaining the first intermediate feature at the N^{th} layer, the first intermediate features at the plurality of scales from the first layer to the N^{th} layer.

The descending order is referred to as the reverse order, and the reverse order of scale is in descending order of scale. Downsampling is a process of reducing a scale. The downsampling may use a scale at a next layer as a target, and feature elements in a feature at each layer are used at intervals, to obtain a feature at the next layer. The first intermediate feature may be referred to as a semantic image feature. The second intermediate feature may be referred to as a position image feature. The semantic image features represent more semantic information, and the semantic image features represent more position information.

In some embodiments, the determining, based on a first intermediate feature ranking first in a reverse order of scale, a second intermediate feature ranking first in the reverse order of scale includes: performing at least one time of convolution on the first intermediate feature ranking first in the reverse order of scale, to obtain the second intermediate feature ranking first in the reverse order of scale. In addition to performing convolution, channel adjustment may be further performed. A quantity of channels of the first intermediate features after the channel adjustment is performed may be consistent.

A scale of a result of downsampling the second intermediate feature ranking m^{th} in the reverse order of scale may be consistent with a scale of a first intermediate feature ranking (m+1)^{th} in the reverse order of scale. The result of downsampling the second intermediate feature ranking m^{th} in the reverse order of scale and the first intermediate feature ranking (m+1)^{th} in the reverse order of scale are fused, and the two may be spliced, or summation or averaging may be performed on the two at the same scale.

For example, the palm recognition device may perform one time of convolution on the feature layer P1 and perform channel adjustment to obtain a feature layer N1. The feature layer N1 is downsampled and is combined with the feature layer P2, and then convolution is performed and channel adjustment is performed to obtain a feature layer N2. The feature layer N2 is downsampled and is combined with the feature layer P3, and then convolution is performed and channel adjustment is performed to obtain a feature layer N3. The feature layer N3 is downsampled and is combined with the feature layer P4, and then convolution is performed and channel adjustment is performed to obtain a feature layer N4. The palm recognition device fuses features at a feature layer N1-4, to obtain an image fusion feature 503.

In some embodiments, an activation function in the convolution is a logistic activation function.

In some embodiments, the palm recognition device upsamples the image features at the plurality of scales in ascending order of scale, to obtain the first intermediate feature; the palm recognition device downsamples the image features at the plurality of scales in descending order of scale, to obtain the second intermediate feature; and the palm recognition device performs feature fusion on the first intermediate feature and the second intermediate feature, to obtain the image fusion feature.

Operation 406: Determine, through a prediction network of the palm part detection model based on the image fusion feature, a palm part frame identifying a palm part in the palm image.

The palm part frame is an identifier configured for representing a position of the palm part in the palm image.

In some embodiments, the palm part frame is determined by the palm part detection model, and the palm part detection model includes a prediction network; and the determining, based on the image fusion feature, a palm part frame identifying a palm part in the palm image includes: performing grid division on the image fusion feature, to obtain a plurality of grid features of the image fusion feature; and inputting the plurality of grid features into the prediction network, and performing prediction on the plurality of grid features, to obtain the palm part frame.

The grid feature is a gridded image fusion feature obtained by performing grid division on the image fusion feature. For example, the palm recognition device performs grid division on the image fusion feature, to obtain the plurality of grid features. The palm recognition device separately performs prediction based on each grid feature through the prediction network, to obtain a prediction result corresponding to each grid feature. Further, the palm recognition device may determine the position of the palm part frame in the palm image based on the prediction results respectively corresponding to the plurality of grid features.

In some embodiments, the palm recognition device is equipped with an infrared camera, and the palm image processing method further includes: obtaining an infrared image collected of a palm part the same as the palm image, where the infrared image is an image obtained by the infrared camera imaging, based on infrared light, the palm part; recognizing a palm part area from the infrared image; and the cropping out a palm part image from the palm image based on the palm part frame includes: determining an intersection between the palm part frame in the palm image and the palm part area in the infrared image; and cropping out the palm part image from the palm image based on the intersection.

In this embodiment, the palm recognition device is further equipped with the infrared camera. The palm recognition device obtains an infrared image corresponding to the same physical palm. The palm recognition device performs area recognition on the infrared image, to determine the palm part area in the infrared image. The infrared image is an image obtained by the infrared camera imaging, based on infrared light, the palm.

In some embodiments, the recognizing a palm part area from the infrared image includes: detecting a finger gap point in the infrared image; and determining the palm part area in the infrared image based on the finger gap point.

For example, the palm recognition device performs detection on the finger gap point in the infrared image, and determines the palm part area in the infrared image based on the finger gap point.

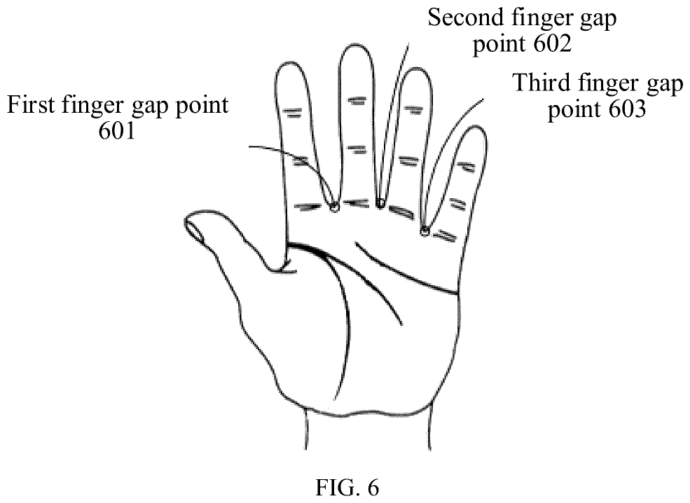

FIG. 6 is a schematic diagram of a finger gap point in a palm. The finger gap point is a first finger gap point 601 between an index finger and a middle finger, or the finger gap point is a second finger gap point 602 between the middle finger and a ring finger, or the finger gap point is a third finger gap point 603 between the ring finger and a little finger.

Because a palm part area in a palm image may exist in any area in the palm image, to determine a position of the palm part area in the palm image, finger gap point detection is performed on the palm image, to obtain at least one finger gap point in the palm image, so that the palm part area can be determined subsequently according to the at least one finger gap point.

Operation 408: Crop out a palm part image from the palm image based on the palm part frame.

The palm part image is an effective recognition area in the palm image, or the palm part image is an area in the palm image in which the palm part is located, or the palm part image is an area in the palm image that can be configured for palm recognition.

In some embodiments, the palm recognition device obtains at least three finger gap points in the infrared image; the finger gap points are sequentially connected, to obtain a finger gap point connecting line; and the palm recognition device crops the infrared image based on the finger gap point connecting line to obtain the palm part area.

In some embodiments, the determining an intersection between the palm part frame in the palm image and the palm part area in the infrared image includes: obtaining a coordinate parameter of the palm part frame in the palm image, and obtaining a coordinate parameter of the palm part area in the infrared image; and determining the intersection between the palm part frame and the palm part area based on the coordinate parameter of the palm part frame and the coordinate parameter of the palm part area.

The palm recognition device obtains the coordinate parameter of the palm part frame in the palm image, and obtains the coordinate parameter of the palm part area in the infrared image; and the palm recognition device obtains the palm part image corresponding to the palm part by cropping the palm image based on the intersection between the coordinate parameter of the palm part frame and the coordinate parameter of the palm part area.

Operation 410: Perform image encryption on the palm part image, to obtain encrypted palm part image data, where the encrypted palm part image data is configured for being transmitted to a server, and the server performs identity recognition based on the encrypted palm part image data.

The encrypted palm part image data is configured for being transmitted to the palm recognition server for decryption and palm part comparison and recognition, to obtain the user identifier corresponding to the palm image. The palm part comparison and recognition refers to comparing and recognizing the palm part feature in the palm part image with a preset palm part feature in the database.

As one of biological features, the palm part has biological uniqueness and distinction. Compared with facial recognition, which is currently widely applied to fields such as identity verification, payment, access control, and bus riding, the palm part is not affected by makeup, a mask, ink glasses, and the like, which can improve accuracy of user identity verification. In some scenarios, such as a pandemic prevention and control scenario, a mask needs to be worn to cover the mouth and the nose. In this case, performing identity verification by using a palm image may be a better option.

Cross-device registration recognition is a capability that is very important for user experience. For two types of associated devices, a user may register in a device of one type, a user identifier of the user is bound with a palm part feature of the user, and then the user may perform identity verification on a device of the other type. Because a mobile phone and an internet of things device have a large difference in image style and image quality, the user can directly perform, through cross-device registration and recognition, identity verification on the internet of things device end after performing registration on the mobile phone end, and the user does not need to perform registration on the two types of devices. For example, after perform registration on the mobile phone end, the user can directly perform identity verification on a device in a store, and does not need to perform registration on the device in the store, to avoid information leaking of the user.

In summary, according to the method provided in this embodiment, the image features at the plurality of scales corresponding to the palm image are obtained by obtaining the palm image and performing feature extraction; feature fusion is performed on the image features at the plurality of scales, to obtain the image fusion feature; prediction is performed based on the image fusion feature, to obtain the palm part frame corresponding to the palm part in the palm image; the palm part image corresponding to the palm part is obtained by cropping the palm image based on the palm part frame; and image encryption is performed on the palm part image, to obtain the encrypted palm part image data, and the encrypted palm part image data is transmitted to the palm recognition server for decryption and palm part comparison and recognition, to obtain a user identifier corresponding to the palm image. In this application, the palm part image corresponding to the palm part is obtained by cropping the palm image, and image encryption, transmission, and decryption are performed only on the palm part image. This reduces time of recognizing the palm image and improves recognition efficiency of palm recognition.

According to the method provided in this embodiment, the slicing operation is performed on the palm image through the backbone network and feature extraction is performed, to obtain the image features at the plurality of scales. Based on the foregoing method, features at the plurality of scales, under different receptive fields, and in different categories are obtained. This improves accuracy of prediction of the palm part frame.

According to the method provided in this embodiment, the image features at the plurality of scales are upsampled through the neck network in ascending order of scale, to obtain the first intermediate feature; the image features at the plurality of scales are downsampled in descending order of scale, to obtain the second intermediate feature; and feature fusion is performed on the first intermediate feature and the second intermediate feature, to obtain the image fusion feature. Based on the foregoing method, the image features at the plurality of scales can be fused. This increases accuracy of detecting a small target in the palm image.

According to the method provided in this embodiment, a gridded image fusion feature is obtained by performing grid division on the image fusion feature. Through the prediction network, prediction is performed based on the gridded image fusion feature, to obtain the palm part frame. Based on the foregoing method, accuracy of prediction of the palm part frame is improved, and security of identity recognition is further ensured based on the palm.

According to the method provided in this embodiment, an infrared image corresponding to a same palm part is obtained, area identification is performed on the infrared image, to determine a palm part area in the infrared image, and based on the intersection between the palm part frame and the palm part area in the infrared image, a palm part image corresponding to the palm part is obtained by cropping the palm image. Based on the foregoing method, through the palm part area in the infrared image and the palm part frame, a palm part image corresponding to the palm part is jointly obtained, so that cropping accuracy of the palm part image is improved, and the obtained palm part image is more accurate.

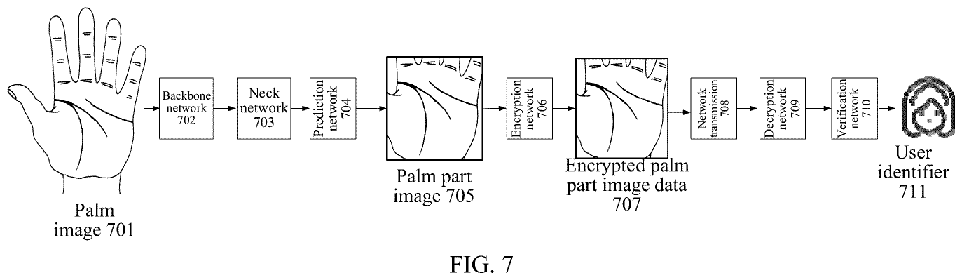

FIG. 7 is a schematic diagram of a palm image processing method according to an exemplary embodiment of this application. The method is performed by a palm recognition device. The method includes:

obtaining, by the palm recognition device, a palm image 701 corresponding to a palm part, and inputting, by the palm recognition device, the obtained palm image 701 into a backbone network 702 for feature extraction, to obtain image features at a plurality of scales corresponding to the palm image 701.

The palm recognition device performs, through a neck network 703, feature fusion on the image features at the plurality of scales, to obtain an image fusion feature.

The palm recognition device performs prediction through a prediction network 704 based on the image fusion feature, to obtain a palm part frame corresponding to a palm part in the palm image 701. The palm recognition device obtains a palm part image 705 corresponding to the palm part by cropping the palm image 701 based on the palm part frame.

The palm recognition device inputs the palm part image 705 into an encryption network 706 for image encryption, to obtain encrypted palm part image data 707.

The palm recognition device transmits the encrypted palm part image data 707 through a network 708 to a decryption network 709 in a palm recognition server for image decryption and performs palm part comparison and recognition through a verification network 710, to obtain a user identifier 711 corresponding to the palm image 701.

In summary, according to the method provided in this embodiment, the palm part image corresponding to the palm part is obtained by cropping the palm image, and image encryption, transmission, and decryption are performed only on the palm part image. This reduces time of recognizing the palm image and improves recognition efficiency of palm recognition.

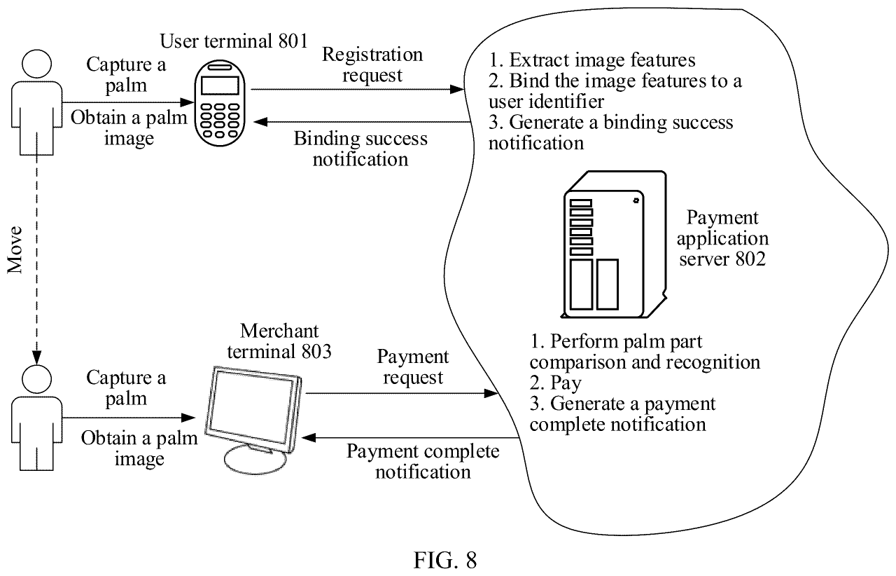

FIG. 8 is a schematic diagram of cross-device payment based on a palm image processing method according to an exemplary embodiment of this application. The method relates to a user terminal 801, a merchant terminal 803, and a payment application server 802.

A payment application is installed in the user terminal 801. The user terminal 801 logs in to the payment application based on a user identifier, and establishes a communication connection with the payment application server 802. Through the communication connection, the user terminal 801 may interact with the payment application server 802. The payment application is installed in the merchant terminal 803. The merchant terminal 803 logs in to the payment application based on a merchant identifier, and establishes a communication connection with the payment application server 802. Through the communication connection, the merchant terminal 803 may interact with the payment application server 802.

A cross-device payment procedure includes the following.

1. A user holds the user terminal 801 at home, captures a physical palm of the user through the user terminal 801, to obtain a palm image of the user, logs in to the payment application based on the user identifier, and transmits a palm image registration request to the payment application server 802, where the palm image registration request carries the user identifier and the palm image.

2. The payment application server 802 receives the palm image registration request transmitted by the user terminal 801, performs feature extraction on the palm image, to obtain a palm part feature of the palm image, stores the palm part feature and the user identifier in correspondence, and transmits a palm image binding success notification to the user terminal 801.

After storing the palm part feature and the user identifier in correspondence, the payment application server 802 uses the palm part feature as a preset palm part feature, and may subsequently determine a corresponding user identifier by using the stored preset palm part feature.

3. The user terminal 801 receives the palm image binding success notification, displays the palm image binding success notification, and prompts the user that the palm image is bound to the user identifier.

The user completes registration of the palm image through interaction between the user terminal 801 of the user and the payment application server 802, and may subsequently implement automatic payment through the palm image.

4. When the user purchases goods in a store to perform a transaction, the merchant terminal 803 captures the physical palm of the user, to obtain the palm image, and based on the payment application that the merchant identifier logs in to, transmits a payment request to the payment application server 802, where the payment request carries the merchant identifier, a consumption amount, and the palm image.

5. After receiving the payment request, the payment application server 802 performs palm part comparison and recognition on the palm image, determines the user identifier of the palm image, determines an account of the user identifier in the payment application, completes transfer through the account, and transmits a payment completion notification to the merchant terminal 803 after the transfer is completed.

After the user performs palm image registration by using the user terminal 801, the user can directly perform payment through the palm part on the merchant terminal 803, and the user does not need to perform palm image registration on the merchant terminal 803. This implements an effect of cross-device palm image recognition, and improves convenience.

6. The merchant terminal 803 receives the payment completion notification, displays the payment completion notification, and prompts the user that payment is completed, so that the user completes a transaction with the merchant for an item, and the user can bring the item away.

In addition, in the foregoing embodiment, the cross-device payment process is implemented through the user terminal 801 and the merchant terminal 803. The merchant terminal 803 may be further replaced with a payment device on a bus, and a cross-device bus riding payment solution is implemented according to the foregoing operations.

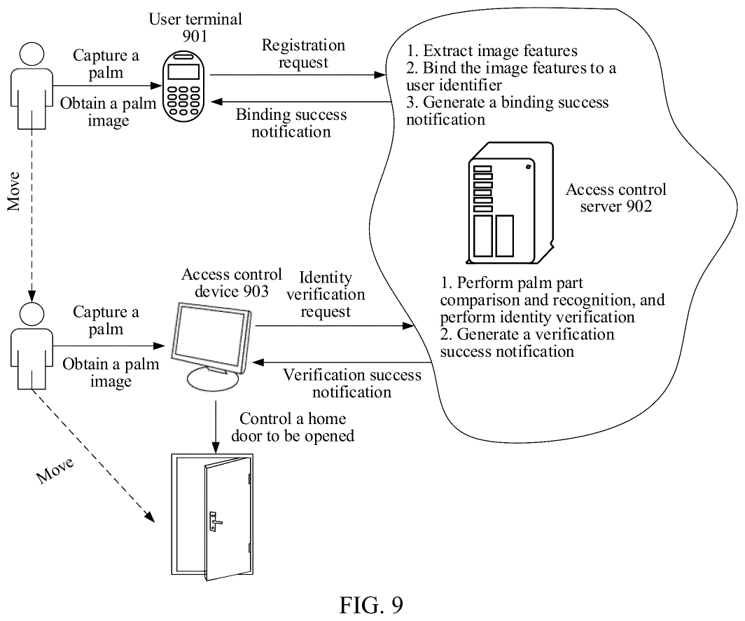

FIG. 9 is a schematic diagram of cross-device identity verification based on a palm image processing method according to an exemplary embodiment of this application. The method relates to a user terminal 901, an access control device 903, and an access control server 902.

The user terminal 901 establishes a communication connection with the access control server 902. Through the communication connection, the user terminal 901 can interact with the access control server 902. The access control device 903 establishes a communication connection with the access control server 902. Through the communication connection, the access control device 903 can interact with the access control server 902.

A cross-device identity verification procedure includes the following.

1. A user holds the user terminal 901 at home, captures a physical palm of the user through the user terminal 901, to obtain a palm image of the user, and transmits a palm part registration request to the access control server 902, where the palm part registration request carries a user identifier and the palm image.

2. The access control server 902 receives the palm part registration request transmitted by the user terminal 901, performs feature extraction on the palm image, to obtain a palm part feature of the palm image, stores the palm part feature and the user identifier in correspondence, and transmits a palm part binding success notification to the user terminal 901.

After storing the palm part feature and the user identifier in correspondence, the access control server 902 may use the palm part feature as a preset palm part feature, and may subsequently determine a corresponding user identifier by using the stored preset palm part feature.

3. The user terminal 901 receives the palm part binding success notification, displays the palm part binding success notification, and prompts the user that the palm image is bound to the user identifier.

The user completes registration of the palm image through interaction between the user terminal 901 of the user and the access control server, and may subsequently implement automatic door opening through the palm image.

4. When the user comes home from the outside, the access control device 903 captures the physical palm of the user, to obtain the palm image of the user, and transmits an identity verification request to the access control server 902, where the identity verification request carries the verification palm image.

5. The access control server 902 receives the identity verification request transmitted by the access control device 903, recognizes the verification palm image, to obtain the user identifier of the palm image, determines that the user is a registered user, and transmits a verification success notification to the access control device 903.

6. The access control device 903 receives the verification success notification transmitted by the access control server 902, and controls, based on the verification success notification, a home door to be opened, so that the user can enter the room.

The foregoing embodiment implements the cross-device identity verification process through the user terminal 901 and the access control device 903.

It may be learned from the foregoing cross-device identity verification scenario that whether in a palm part registration stage of interaction between the user terminal 901 and the access control server 902, or in a palm image processing stage of interaction between the another terminal device and the server, after obtaining the palm image, the user terminal 901 or the another terminal device crops and encrypts an area in which the palm part is located in the palm image, transmits the palm image of the area in which the palm part is located to the server, so that the server performs palm part comparison and recognition. In addition, in the palm part comparison and recognition stage, the access control server 902 compares the palm part feature with the preset palm part feature, to obtain a recognition result of a current user.

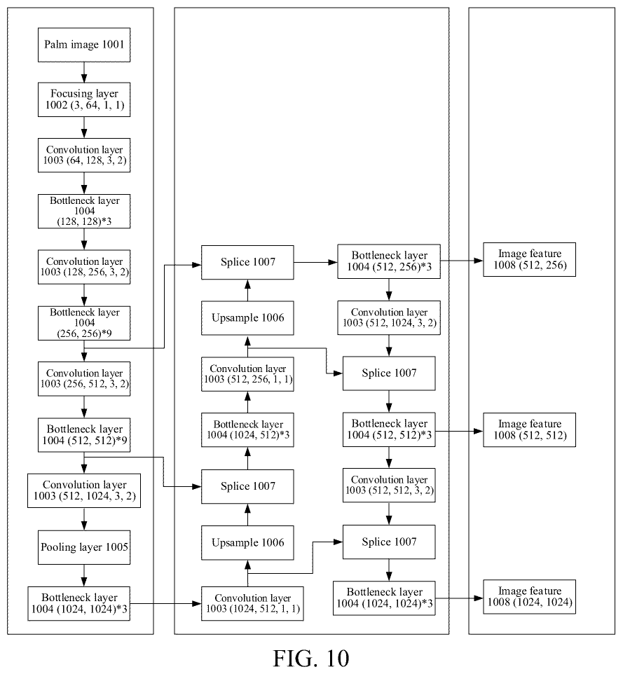

FIG. 10 is a schematic diagram of a palm image processing method according to an exemplary embodiment of this application. The method is performed by a palm recognition device. The method includes:

obtaining, by the palm recognition device, a palm image 1001 corresponding to a palm part, inputting the palm image 1001 into a focusing layer 1002 in a backbone network, and performing, by the focusing layer 1002, a slicing operation on the palm image 1001, to obtain image features at a plurality of scales. The image features are input into a convolution layer 1003 for convolution and channel adjustment, and then are input into a bottleneck layer 1004 for feature extraction. A pooling layer 1005 is configured to pool the image features.

For example, the palm image 1001 is input into the focusing layer 1002, and the focusing layer 1002 performs a slicing operation on the palm image 1001, to obtain the image features at the plurality of scales that are represented as (3, 64, 1, 1). The image features obtained by performing convolution and channel adjustment at the convolution layer 1003 are represented as (64, 128, 3, 2). After passing through the bottleneck layer 1004, the image features are represented as (128, 128)*3. The image features obtained by performing convolution and channel adjustment at the convolution layer 1003 are represented as (128, 256, 3, 2). The image features obtained by passing through the bottleneck layer 1004 are represented as (256, 256)*3. The image features (256, 256)*3 obtained by performing convolution and channel adjustment at the convolution layer 1003 are represented as (256, 512, 3, 2). The image features obtained by passing through the bottleneck layer 1004 are represented as (512, 512)*9. The image features obtained by performing convolution and channel adjustment at the convolution layer 1003 again are represented as (512, 1024, 3, 2). The image features obtained by pooling the image at the pooling layer 1005 and passing through the bottleneck layer 1004 are represented as (1024, 1024)*3. After the image features (1024, 1024)*3 are upsampled 1006 and spliced 1007 with the image features (512, 512)*9, the image features obtained by passing through the bottleneck layer 1004 are represented as (1024, 512)*3. The image features (1024, 512)*3 obtained by performing convolution and channel adjustment at the convolution layer 1003 are represented as (512, 256, 1, 1). After the image features (512, 256, 1, 1) are upsampled 1006 and spliced 1007 with the image features (256, 512, 3, 2), the image features obtained by passing through the bottleneck layer 1004 are represented as (512, 256)*3. The image features (512, 256)*3 obtained by performing convolution and channel adjustment at the convolution layer 1003 are represented as (256, 256, 3, 2). After the image features (256, 256, 3, 2) are spliced 1007 with the image features (512, 256, 1, 1), the image features obtained by passing through the bottleneck layer 1004 are represented as (512, 512)*3. The image features (512, 512)*3 obtained by performing convolution and channel adjustment at the convolution layer 1003 are represented as (512, 512, 3, 2). After the image features (512, 512, 3, 2) are spliced 1007 with the image features represented as (1024, 512, 1, 1), the image features obtained by passing through the bottleneck layer 1004 are represented as (1024, 1024)*3. The final output image features 1008 at the plurality of scales are: (512, 256), (512, 512), and (1024, 1024). (x, y, a, b), where x and y may respectively represent two dimensions of a feature matrix, and a and b may respectively represent a quantity of channels and a scale. (x, y)*b, where x and y may respectively represent two dimensions of the feature matrix, and b may represent the quantity of channels. (x, y), where x and y may respectively represent two dimensions of the feature matrix.

The palm recognition device performs feature fusion on the image features 1008 at the plurality of scales, to obtain an image fusion feature. The palm recognition device performs prediction based on the image fusion feature, to obtain a palm part frame corresponding to a palm part in the palm image 1001. The palm recognition device obtains a palm part image corresponding to the palm part by cropping the palm image 1001 based on the palm part frame. The palm recognition device performs image encryption on the palm part image, and transmits the palm part image to the palm recognition server through the network for image decryption and palm part comparison and recognition, to obtain a user identifier corresponding to the palm image 1001.

In summary, according to the method provided in this embodiment, the slicing operation is performed on the palm image through the backbone network and feature extraction is performed, to obtain the image features at the plurality of scales. Based on the foregoing method, features at the plurality of scales, under different receptive fields, and in different categories are obtained. This improves accuracy of prediction of the palm part frame.

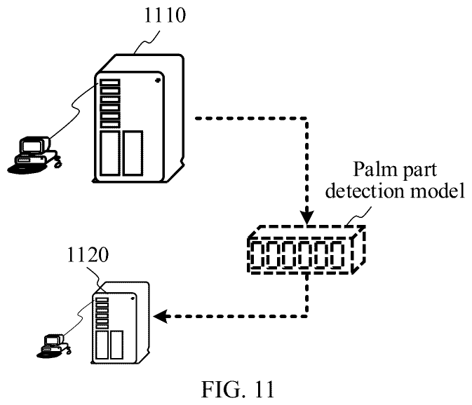

The prediction of the palm part frame related in this application may be implemented based on a palm part detection model. The solution includes a palm part detection model generation stage and a palm part frame prediction stage. FIG. 11 is a framework diagram of a palm part detection model generation stage and a palm part frame prediction stage according to an exemplary embodiment of this application. As shown in FIG. 11, in the palm part detection model generation stage, after obtaining a palm part detection model by using a preset training sample dataset (including a sample palm image and a sample palm part image), a palm part detection model generation device 1110 generates a palm part frame based on the palm part detection model. In the palm part frame prediction stage, the palm part frame prediction processing device 1120 processes the input palm image based on the palm part detection model, to obtain a prediction result of the palm image, for example, determines an area and a position of a palm part in the palm image.

The foregoing palm part detection model generation device 1110 and the palm part frame prediction processing device 1120 may be computer devices. For example, the computer devices may be fixed computer devices such as a personal computer or a server, or the computer devices may also be mobile computer devices such as a tablet computer or an e-book reader.

In some embodiments, the palm part detection model generation device 1110 and the palm part frame prediction processing device 1120 may be the same device, or the palm part detection model generation device 1110 and the palm part frame prediction processing device 1120 may be different devices. In addition, when the palm part detection model generation device 1110 and the palm part frame prediction processing device 1120 are different devices, the palm part detection model generation device 1110 and the palm part frame prediction processing device 1120 may be the same type of devices. For example, both the palm part detection model generation device 1110 and the palm part frame prediction processing device 1120 may be servers. Alternatively, the palm part detection model generation device 1110 and the palm part frame prediction processing device 1120 may be different types of devices. For example, the palm part frame prediction processing device 1120 may be a personal computer or a terminal, and the palm part detection model generation device 1110 may be a server or the like. Specific types of the palm part detection model generation device 1110 and the palm part frame prediction processing device 1120 are not limited in the embodiments of this application.

The foregoing embodiments describe the palm image processing method, and the following describes a method for training a palm part detection model.

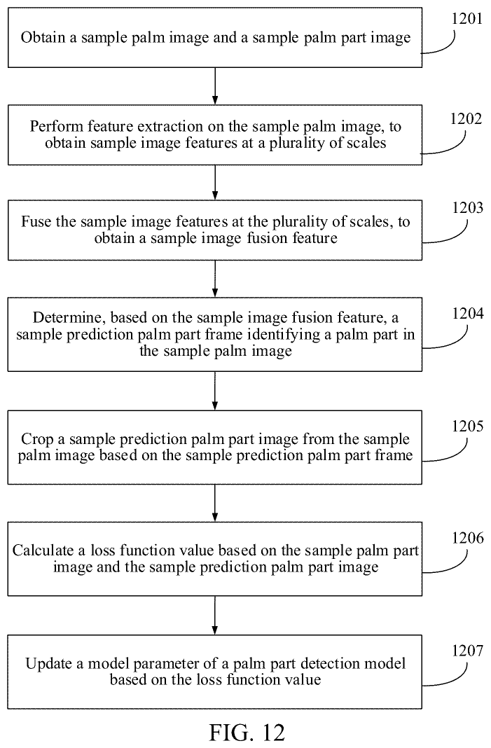

FIG. 12 is a flowchart of a method for training a palm part detection model according to an exemplary embodiment of this application. The method is performed by a palm recognition device. The method includes the following operations.

Operation 1201: Obtain a sample palm image and a sample palm part image.

The sample palm image is an image of a to-be-determined user identifier. The sample palm image includes a palm. The palm is an image of a physical palm of a user whose identity is to be verified. The sample palm image may further include other information, such as fingers of the user, a scene in which the palm of the user is captured, and the like. The sample palm image may be obtained by capturing, by the palm recognition device, a physical palm of a user whose identity is to be verified, or may be transmitted by another device.

For example, the palm recognition device is a cash register device in a store, and the cash register device in the store captures a physical palm of a user through a camera, to obtain the sample palm image. Alternatively, the palm recognition device is a palm image recognition server, and after capturing a sample palm image of a user, a cash register device in a store transmits the sample palm image to the palm image recognition server.

The sample palm part image is an effective recognition area labeled in the sample palm image, or the sample palm part image is an area in the sample palm image in which the labeled palm part is located, or the sample palm part image is an area in the sample palm image that is labeled and that can be configured for recognition.

Operation 1202: Perform feature extraction on the sample palm image, to obtain sample image features at a plurality of scales.

The sample palm image is an image obtained by capturing a physical palm. The sample palm image includes an image of all or a part of the physical palm. For case of description, an image of the physical palm in the sample palm image is referred to as a palm subsequently. The palm included in the sample palm image may be a physical palm of a user whose identity recognition is to be performed. The palm in the sample palm image includes at least a palm part, may further include the fingers or a part of the arm, and may further include an image of an environment in which the physical palm is located when the physical palm is captured.

A scale is a size of a sample image feature, and may be represented by a matrix dimension number, such as 100*100, 80*80, 60*60, or 40*40. The plurality of scales refer to two or more scales, and each scale is different. A maximum scale in the plurality of scales may be the same as a scale of the sample palm image, and is generally smaller than the scale of the sample palm image.

The sample palm image may be obtained by capturing, by the palm recognition device, a physical palm of a user whose identity is to be verified, or may be transmitted by another device. The palm recognition device may directly collect an image of the physical palm, to obtain the sample palm image. The palm recognition device may also collect the image of the physical palm through an image collector connected to the sample palm image, to obtain the sample palm image. The palm recognition device can perform feature extraction on the obtained sample palm image, to obtain sample image features at a plurality of scales corresponding to the sample palm image.

For example, the palm recognition device is a cash register device in a store, and the cash register device in the store captures a physical palm of a user through a camera, to obtain the sample palm image. Alternatively, the palm recognition device is a sample palm image recognition server, and after capturing a sample palm image of a user, a cash register device in a store transmits the sample palm image to the sample palm image recognition server.

For example, the sample image features at the plurality of scales may be respectively extracted from low-resolution images at the plurality of scales by downsampling a high-resolution sample palm image into the low-resolution images at the plurality of scales. The high resolution and the low resolution are relative concepts, and the high resolution is a resolution higher than the low resolution.

For example, a size of the input sample palm image is 640*640, and sizes of the output sample image features at the plurality of scales are: 80*80, 40*40, and 20*20.

Operation 1203: Fuse the sample image features at the plurality of scales, to obtain a sample image fusion feature.

The palm recognition device may perform feature fusion on the sample image features at the plurality of scales, to obtain a sample image fusion feature.

The sample image features at the plurality of scales refer to features obtained by performing feature extraction on images at the plurality of scales. Sample image features at different scales may express different information. In the sample image features at the plurality of scales, sample image features at larger scales express more position information, and sample image features at smaller scales express more semantic information.

For example, the palm recognition device extracts features at the plurality of scales, under different receptive fields, and in different categories, and fuses the sample image features at the plurality of scales, to obtain the sample image fusion feature corresponding to the sample palm image.

Operation 1204: Determine, based on the sample image fusion feature, a sample prediction palm part frame identifying a palm part in the sample palm image.

The sample prediction palm part frame is an identifier configured for representing a position of the palm part in the sample palm image. The sample prediction palm part frame includes the palm part in the sample palm image. A boundary of the sample prediction palm part frame encloses the palm part in the sample palm image.

In some embodiments, a shape of the sample prediction palm part frame may be a regular shape, for example, may be at least one of a rectangle, a square, a rhombus, a hexagon, a circle, or a triangle. The shape of the sample prediction palm part frame may alternatively be an irregular shape. The regular shape is a shape that can be drawn by using a fixed parameter and based on a fixed rule. The irregular shape cannot be drawn by using the fixed parameter and based on the fixed rule, and can generally only be represented by a set of points that constitute the irregular shape.

The palm recognition device can perform prediction based on the sample image fusion feature by using artificial intelligence, to determine the sample prediction palm part frame identifying the palm part in the sample palm image.

In some embodiments, a computer device can determine, based on the sample image fusion feature, the position of the sample prediction palm part frame in the sample palm image that identifies the palm part in the sample palm image. When the sample prediction palm part frame is of the regular shape, the position may be represented by a value of the fixed parameter required for drawing the regular shape, for example, may be represented by a position of a fixed point of the sample prediction palm part frame and a size parameter of the sample prediction palm part frame. The fixed point is a point whose position is fixed relative to the sample prediction palm part frame. The size parameter is a parameter representing a size of the sample prediction palm part frame. For example, when the sample prediction palm part frame is of the rectangle shape, the fixed point may be any corner point or a center point of the rectangle, and the size parameter is a side length of an adjacent side of the sample prediction palm part frame.

Operation 1205: Crop out a sample prediction palm part image from the sample palm image based on the sample prediction palm part frame.

The sample prediction palm part image is an effective recognition area in the sample palm image, or the sample prediction palm part image is an area in the sample palm image in which the palm part is located, or the sample prediction palm part image is an area in the sample palm image that can be configured for palm recognition.

For example, the palm recognition device crops, based on the position of the sample prediction palm part frame, an image area located outside the sample prediction palm part frame in the sample palm image, and uses a remaining image as the sample prediction palm part image.

Operation 1206: Calculate a loss function value based on the sample palm part image and the sample prediction palm part image.

For example, the palm recognition device calculates the loss function value based on the sample palm part image and the sample prediction palm part image.

Operation 1207: Update a model parameter of the palm part detection model based on the loss function value.

For example, the palm recognition device updates the model parameter of the palm part detection model based on the loss function value.

Updating of the model parameter refers to updating a network parameter in the palm part detection model, or updating a network parameter of each network module in the model, or updating a network parameter of each network layer in the model, but is not limited thereto. This is not limited in the embodiments of this application.

The model parameter of the palm part detection model includes at least one of a network parameter of a backbone network, a network parameter of a neck network, and a network parameter of a prediction network in the palm part detection model.

In summary, according to the method provided in this embodiment, the sample image features at the plurality of scales corresponding to the sample palm image are obtained by performing feature extraction on the sample palm image; feature fusion is performed on the sample image features at the plurality of scales, to obtain the sample image fusion feature; prediction is performed based on the sample image fusion feature, to obtain the sample prediction palm part frame identifying the palm part in the sample palm image; the sample palm image is cropped based on the sample prediction palm part frame to obtain the sample prediction palm part image corresponding to the palm part; a loss function value is calculated based on the sample prediction palm part image and the sample prediction palm part image; and the model parameter of the palm part detection model is updated based on the loss function value, so that the trained palm part detection model can have higher prediction accuracy of the sample prediction palm part frame, to obtain a more accurate sample prediction palm part frame.

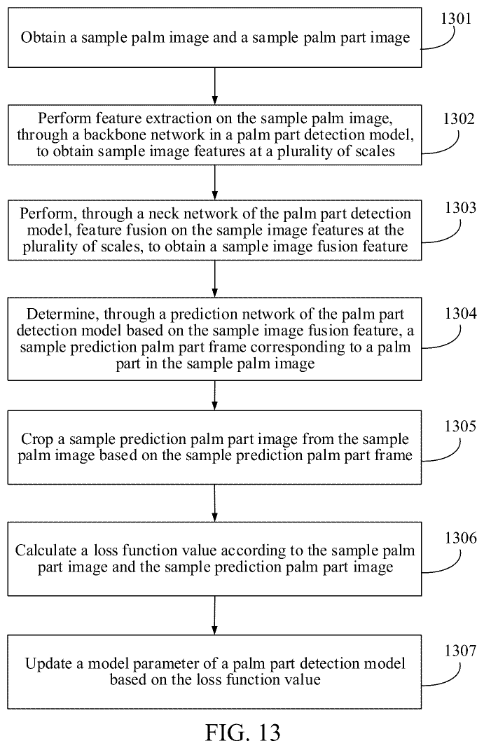

FIG. 13 is a flowchart of a method for training a palm part detection model according to an exemplary embodiment of this application. The method is performed by a palm recognition device. The method includes the following operations.

Operation 1301: Obtain a sample palm image and a sample palm part image.

The sample palm image is an image of a to-be-determined user identifier. The sample palm image includes a palm. The palm is an image of a physical palm of a user whose identity is to be verified. The sample palm image may further include other information, such as fingers of the user, a scene in which the palm of the user is captured, and the like. The sample palm image may be obtained by capturing, by the palm recognition device, a physical palm of a user whose identity is to be verified, or may be transmitted by another device.

The sample palm part image is an effective recognition area labeled in the sample palm image, or the sample palm part image is an area in the sample palm image in which the labeled palm part is located, or the sample palm part image is an area in the sample palm image that is labeled and that can be configured for recognition.

For example, the sample palm image is collected in a manner in which 50 to 100 sample palm images are obtained. The sample palm image is cleaned up by finding a duplicate value, a missing value, and an outlier, so that a valid sample palm image is obtained. Code for cleaning up the sample palm image may be represented as:

```
allocate output Pixel Value [image width][image height]
allocate window [window width×window height]
edge x=(window width/2) rounded down
edge y=(window height/2) rounded down
  for x from edge x to image width−edge x do
  for y from edge y to image height−edge y do
    i=0
    for fx from 0 to window width do
      for fy from 0 to window height do
        window[i]=input Pixel Value[x+fx−edge x][y+fy−edge y]
          i=i+1
    sort entries in window [ ]
    output Pixel Value[x][y]=window [window width*window height/2]
```

A collection distance requirement of the sample palm image is that the palm part is placed at a position of 5 cm, 8 cm, 10 cm, 12 cm, or 15 cm from the palm recognition device for collection, and collection is performed at each distance for 10 to 15 seconds.

The sample palm part image is obtained in a manner in which a palm part area in the sample palm image is labeled by using a labeling tool Labeling. Code for labeling the palm part area may be represented as:

```
<object>
    <name>plam</name>
    <pose>Unspecified</pose>
    <truncated>0</truncated>
    <difficult>0</difficult>
    <bndbox>
      <xmin>45</xmin>
      <ymin>34</ymin>
      <xmax>104</xmax>
      <ymax>84</ymax>
    </bndbox>
  </object>
```

In the foregoing code, 45 represents a minimum value in the palm part area on an x-axis, 104 represents a maximum value in the palm part area on the x-axis, 34 represents a minimum value in the palm part area on a y-axis, and 84 represents a minimum value in the palm part area on the y-axis.

The labeling tool Labeling replaces the conventional one-hot encoded label vector yₕₒₜ with the updated label vector ŷᵢ with reference to the uniform distribution theorem.

$${\hat{y}}_{i} = {y}_{hot} ( 1 - α ) + α / k$$

In the formula, k is a total quantity of categories of the multi-classification, and α is a small hyperparameter (generally 0.1).

That is, the label vector ŷᵢ may be represented as:

$${\hat{y}}_{i} = \{ \begin{matrix}1 - α , & i = a quantity of categories \\ \frac{α}{k} , & i \neq a quantity of categories\end{matrix}$$

The label vector ŷᵢ is equivalent to adding noise to a real distribution, to prevent the model from being too confident about a correct label, so that output values of predicted positive and negative samples do not differ as greatly. This avoids overfitting and improves a generalization capability of the model.

Operation 1302: Perform feature extraction on the sample palm image, through a backbone network in a palm part detection model, to obtain sample image features at a plurality of scales.

For example, the palm recognition device captures a physical palm of the user, to obtain the sample palm image. The sample palm image includes the palm. The palm may be a left palm of the user or a right palm of the user.

For example, the palm recognition device is an internet of things device. The internet of things device captures the left palm of the user through a camera, to obtain the sample palm image. The internet of things device may be a cash register device in a store. For another example, when the user shops for a transaction in the store, the user extends a palm toward a camera of a payment terminal in the store, and the payment terminal in the store captures the physical palm of the user through the camera, to obtain the sample palm image.

In some embodiments, the palm recognition device establishes a communication connection with another device, and receives, through the communication connection, a sample palm image transmitted by the another device. For example, the palm recognition device is a payment application server, and the another device may be a payment terminal. After the payment terminal captures the physical palm of the user, to obtain the sample palm image, the sample palm image is transmitted to the payment application server through the communication connection between the payment terminal and the payment application server, so that the payment application server can determine a user identifier of the sample palm image.

In some embodiments, the sample prediction palm part frame is obtained by prediction by a palm part detection model, and the palm part detection model includes a backbone network; and the performing feature extraction on the sample palm image, to obtain sample image features at a plurality of scales includes: inputting the sample palm image into the backbone network; performing a slicing operation on the sample palm image through the backbone network, to obtain slice images at the plurality of scales; and respectively performing feature extraction on the slice images at the plurality of scales through the backbone network, to obtain the sample image features at the plurality of scales.

The palm part detection model is an artificial intelligence model, may be a deep learning model, or may be a neural network model. The palm part detection model has at least a function of determining, based on a sample image fusion feature, a sample prediction palm part frame identifying a palm part in the sample palm image. The backbone network is a structure configured for extracting sample image features at a plurality of scales from the sample palm image in the palm part detection model. The slicing operation is an operation of segmenting the sample palm image to generate images at smaller scales. The smaller scale means that a scale of the generated image is smaller than the scale of the sample palm image. Pixels in the slice image are derived from the sample palm image.

The palm recognition device may input the sample palm image into the backbone network, and the backbone network performs a slicing operation, to obtain the slice images at the plurality of scales. The palm recognition device may perform feature extraction on the slice images at the plurality of scales, to obtain the sample image features at the plurality of scales corresponding to the sample palm image.

In some embodiments, the performing a slicing operation on the sample palm image through the backbone network, to obtain slice images at the plurality of scales includes: determining, through the backbone network and based on the sample palm image, a slice image at a maximum scale in the plurality of scales; and using, through the backbone network, the slice image at the maximum scale as a first layer, and starting downsampling layer by layer, to obtain the slice images at the plurality of scales including the slice image at the first layer.

A computer device may first determine, based on the sample palm image, the slice image at the maximum scale in the plurality of scales. The scale of the sample image feature at the maximum scale may be smaller than or equal to the scale of the sample palm image. The computer device may downsample the sample palm image once, to generate the slice image at the maximum scale in the plurality of scales.

Downsampling the sample palm image is a process of sampling at least one pixel in the sample palm image. Pixels obtained through downsampling are spliced in sequence in the sample palm image, so that a slice image at a smaller scale can be obtained.

If a quantity of the plurality of scales is N, the plurality of scales are N scales. The N scales are all different scales, and therefore, there is a maximum scale in the N scales. The slice image at the maximum scale is used as a first layer, downsampling layer by layer is started from the first layer, an n^{th} layer is downsampled to obtain a slice image at an (n+1)^{th} layer, and an (N−1)^{th} layer is downsampled to obtain a slice image at the N^{th} layer. n is a positive integer from 1 to N−1. Finally, a total of N slice images at 1 to N layers may be obtained.

In this embodiment, the slice images at the plurality of scales are obtained by downsampling layer by layer, which provides a new way to obtain the slice images at the plurality of scales by segmenting the sample palm image.

In some embodiments, the performing a slicing operation on the sample palm image through the backbone network, to obtain slice images at the plurality of scales includes: downsampling and splicing, through the backbone network, pixels in the sample palm image at the plurality of scales, to obtain the slice images at the plurality of scales. There are two adjacent pixels in slice images at different scales, and a quantity of pixels between the two pixels at which sampling occurs in the sample palm image is different.

In this embodiment, the palm recognition device may sample the pixels from the sample palm image at each scale by using a sampling interval at the scale, and splice the sampled pixels according to a relative position relationship in the sample palm image, to obtain a slice image at each scale. The sampling interval is a quantity of pixels that are spaced, including intervals of pixels in two directions: a row and a column. The scale is negatively correlated with the sampling interval. A larger scale indicates a smaller sampling interval. A smaller scale indicates a larger sampling interval. Pixels that are not sampled in the sample palm image may be concentrated to a channel of a sample image feature.

For example, at a maximum scale in the plurality of scales, in the sample palm image, sampling is performed on every other column. That is, a pixel is selected every other pixel in the row direction, and the selected pixels are spliced, to obtain the slice image. Information in the spliced slice image is not lost, but size information in the sample palm image is concentrated on the channel, and a convolution operation is performed on an obtained new image, to obtain a downsampling feature map without information loss.

For another example, at a second largest scale in the plurality of scales, in the sample palm image, sampling is performed in every two columns. That is, pixels are selected every two pixels, and the selected pixels are spliced, to obtain the slice image. Information in the spliced slice image is not lost, but size information in the sample palm image is concentrated on the channel, and a convolution operation is performed on an obtained new image, to obtain a downsampling feature map without information loss.

For example, a size of an original image is: 640*640*3. Through the slicing operation, a feature map of 320*320*12 is obtained. 640*640 in the original image is configured for representing width*height, and 3 in the original image is configured for representing a length (also referred to as a quantity of channels) of a feature vector corresponding to each pixel.

Operation 1303: Perform, through a neck network of the palm part detection model, feature fusion on the sample image features at the plurality of scales, to obtain the sample image fusion feature.

The sample prediction palm part frame is obtained by prediction by the palm part detection model, and the palm part detection model includes a neck network; and the fusing the sample image features at the plurality of scales, to obtain a sample image fusion feature includes: performing, through the neck network, feature fusion on the sample image features at the plurality of scales, to obtain the sample image fusion feature.

The neck network belongs to the palm part detection model and is a structure configured for performing feature fusion on the sample image features at the plurality of scales to obtain the sample image fusion feature. The neck network is connected to the backbone network, and is configured to receive the sample image features at the plurality of scales output by the backbone network.

The sample image features at the plurality of scales refer to features obtained by performing feature extraction on images at the plurality of scales. Sample image features at different scales may express different information. In the sample image features at the plurality of scales, sample image features at larger scales express more position information, and sample image features at smaller scales express more semantic information.

For example, the palm recognition device extracts features at the plurality of scales, under different receptive fields, and in different categories, and fuses the sample image features at the plurality of scales, to obtain the sample image fusion feature corresponding to the sample palm image.

In some embodiments, the performing, through the neck network, feature fusion on the sample image features at the plurality of scales, to obtain the sample image fusion feature includes: performing, through the neck network, fusion at the same scale on the sample image features at the plurality of scales, to obtain the sample image fusion feature. The fusion of the sample image features at the same scale may be summation or averaging.

The palm recognition device fuses the sample image features at the plurality of scales, which increases detection accuracy of a small target, so that the sample prediction palm part frame can be detected more accurately. In this way, the sample prediction palm part image can be cropped out more accurately. This further reduces a data amount of the sample prediction encrypted palm part image data, improves identity recognition efficiency, and ensures security of identity recognition.

In some embodiments, the performing, through the neck network, feature fusion on the sample image features at the plurality of scales, to obtain the sample image fusion feature includes: performing, through the neck network, feature fusion based on the sample image features at the plurality of scales, to obtain first intermediate features at the plurality of scales; performing, through the neck network, feature fusion at the plurality of scales based on the first intermediate features at the plurality of scales, to obtain second intermediate features at the plurality of scales; and performing, through the neck network, feature fusion on the second intermediate features at the plurality of scales, to obtain the sample image fusion feature.

The feature fusion at the plurality of scales refers to performing feature fusion at different scales respectively. The first intermediate features at the plurality of scales may be in a one-to-one correspondence with the sample image features at the plurality of scales. The first intermediate features at the plurality of scales may be in a one-to-one correspondence with the second intermediate features at the plurality of scales. The sample image features at the plurality of scales may be consistent with the first intermediate features at the plurality of scales. The first intermediate features at the plurality of scales may be consistent with the second intermediate features at the plurality of scales. The performing feature fusion on the second intermediate features at the plurality of scales may be fusing, at the same scale, the second intermediate features at the plurality of scales. The fusion may be summation or averaging.

In this embodiment, features at different scales are fused and are finally fused into the sample image fusion feature, which can fully express detailed features in the sample palm image, so that a sample prediction palm part frame is detected more accurately. In this way, the sample prediction palm part image can be cropped out more accurately. This further reduces a data amount of the sample prediction encrypted palm part image data, improves identity recognition efficiency, and ensures security of identity recognition.

In some embodiments, the plurality of scales are N scales, N is a positive integer greater than 1, and the extracting, based on the sample image features at the plurality of scales, first intermediate features at the plurality of scales includes: determining, based on a sample image feature ranking first in a positive order of scale, a first intermediate feature ranking first in the positive order of scale; upsampling layer by layer starting from the first intermediate feature ranking first in the positive order of scale, and fusing a result of upsampling a first intermediate feature ranking n^{th} in the positive order of scale with a sample image feature ranking (n+1)^{th} in the positive order of scale, to obtain a first intermediate feature ranking (n+1)^{th} in the positive order of scale; and determining, when obtaining a first intermediate feature at an N^{th} layer, the first intermediate features at the plurality of scales from a first layer to the N^{th} layer. n is a positive integer from 1 to N−1; and the positive order of scale is in ascending order of scale.

The ascending order is referred to as the positive order, and the positive order of scale is in ascending order of scale. Upsampling is a process of increasing the scale. The upsampling may use a scale at a next layer as a target, and adjacent feature elements in a feature at each layer are interpolated, to obtain a feature at the next layer.

In some embodiments, the determining, based on a sample image feature ranking first in a positive order of scale, a first intermediate feature ranking first in the positive order of scale includes: performing at least one time of convolution on the sample image feature ranking first in the positive order of scale, to obtain the first intermediate feature ranking first in the positive order of scale. In addition to performing convolution, channel adjustment may be further performed. A quantity of channels of the first intermediate features after the channel adjustment is performed may be consistent.

In some embodiments, a scale of a result of upsampling the first intermediate feature ranking n^{th} in the positive order of scale may be the same as a scale of a sample image feature ranking (n+1)^{th} in the positive order of scale. The result of upsampling the first intermediate feature ranking n^{th} in the positive order of scale and the sample image feature ranking (n+1)^{th} in the positive order of scale are fused, and the two may be spliced, or summation or averaging may be performed on the two at the same scale.

For example, FIG. 5 is a schematic diagram of sample image feature fusion. A palm recognition device performs feature extraction on a sample palm image 501, to obtain sample image features 502 at a plurality of scales corresponding to the sample palm image 501. The sample image features 502 include a feature layer T1, a feature layer T2, a feature layer T3, and a feature layer T4. After the sample image feature 502 is obtained, one time of convolution is performed on the feature layer T4 and channel adjustment is performed to obtain a feature layer P4. The feature layer P4 is upsampled and is combined with the feature layer T3, and then convolution is performed and channel adjustment is performed to obtain a feature layer P3. The feature layer P3 is upsampled and is combined with the feature layer T2, and then convolution is performed and channel adjustment is performed to obtain a feature layer P2. The feature layer P2 is upsampled and is combined with the feature layer T1, and then 1*1 convolution is performed and channel adjustment is performed to obtain a feature layer P1.

In some embodiments, the plurality of scales are N scales, N is a positive integer greater than 1, and the performing feature fusion at the plurality of scales based on the first intermediate features at the plurality of scales, to obtain second intermediate features at the plurality of scales includes: determining, based on a first intermediate feature ranking first in a reverse order of scale, a second intermediate feature ranking first in the reverse order of scale; downsampling layer by layer starting from the second intermediate feature ranking first in the reverse order of scale, and fusing a result of downsampling a second intermediate feature ranking m^{th} in the reverse order of scale with a first intermediate feature ranking (m+1)^{th} in the reverse order of scale, to obtain a second intermediate feature ranking (n+1)^{th} in the reverse order of scale, where m is an integer from 1 to N−1; and the reverse order of scale is in descending order of scale; and determining, when obtaining the first intermediate feature at the N^{th} layer, the first intermediate features at the plurality of scales from the first layer to the N^{th} layer.

The descending order is referred to as the reverse order, and the reverse order of scale is in descending order of scale. Downsampling is a process of reducing a scale. The downsampling may use a scale at a next layer as a target, and feature elements in a feature at each layer are used at intervals, to obtain a feature at the next layer. The first intermediate feature may be referred to as a semantic sample image feature. The second intermediate feature may be referred to as a position sample image feature. The semantic sample image features represent more semantic information, and the semantic sample image features represent more position information.

In some embodiments, the determining, based on a first intermediate feature ranking first in a reverse order of scale, a second intermediate feature ranking first in the reverse order of scale includes: performing at least one time of convolution on the first intermediate feature ranking first in the reverse order of scale, to obtain the second intermediate feature ranking first in the reverse order of scale. In addition to performing convolution, channel adjustment may be further performed. A quantity of channels of the first intermediate features after the channel adjustment is performed may be consistent.

A scale of a result of downsampling the second intermediate feature ranking m^{th} in the reverse order of scale may be consistent with a scale of a first intermediate feature ranking (m+1)^{th} in the reverse order of scale. The result of downsampling the second intermediate feature ranking m^{th} in the reverse order of scale and the first intermediate feature ranking (m+1)^{th} in the reverse order of scale are fused, and the two may be spliced, or summation or averaging may be performed on the two at the same scale.

For example, the palm recognition device may perform one time of convolution on the feature layer P1 and perform channel adjustment to obtain a feature layer N1. The feature layer N1 is downsampled and is combined with the feature layer P2, and then convolution is performed and channel adjustment is performed to obtain a feature layer N2. The feature layer N2 is downsampled and is combined with the feature layer P3, and then convolution is performed and channel adjustment is performed to obtain a feature layer N3. The feature layer N3 is downsampled and is combined with the feature layer P4, and then convolution is performed and channel adjustment is performed to obtain a feature layer N4. The palm recognition device fuses features at a feature layer N1-4, to obtain an image fusion feature 503.

In some embodiments, an activation function in the convolution is a logistic activation function.

In some embodiments, the palm recognition device upsamples the sample image features at the plurality of scales in ascending order of scale, to obtain the first intermediate feature; the palm recognition device downsamples the sample image features at the plurality of scales in descending order of scale, to obtain the second intermediate feature; and the palm recognition device performs feature fusion on the first intermediate feature and the second intermediate feature, to obtain the sample image fusion feature.

Operation 1304: Determine, through a prediction network of the palm part detection model based on the sample image fusion feature, a sample prediction palm part frame identifying a palm part in the sample palm image.

The sample prediction palm part frame is an identifier configured for representing a position of the palm part in the sample palm image.

In some embodiments, the sample prediction palm part frame is determined by the palm part detection model, and the palm part detection model includes a prediction network; and the determining, based on the sample image fusion feature, a sample prediction palm part frame identifying a palm part in the sample palm image includes: performing grid division on the sample image fusion feature, to obtain a plurality of grid features of the sample image fusion feature; and inputting the plurality of grid features into the prediction network, and performing prediction on the plurality of grid features, to obtain the sample prediction palm part frame.

For example, the palm recognition device performs grid division on the sample image fusion feature, to obtain gridded sample image fusion features; and the palm recognition device inputs the gridded fusion features into the prediction network, and the prediction network performs prediction on each grid, to obtain the sample prediction palm part frame. Prediction is performed on the plurality of grid features, to obtain the sample prediction palm part frame. Specifically, a position of the sample prediction palm part frame may be determined based on prediction results of the plurality of grid features.

In some embodiments, the palm recognition device is equipped with an infrared camera, and the sample palm image processing method further includes: obtaining an infrared image collected of a palm part the same as the sample palm image, where the infrared image is an image obtained by the infrared camera imaging, based on infrared light, the palm part; recognizing a palm part area from the infrared image; and the cropping out a sample prediction palm part image from the sample palm image based on the sample prediction palm part frame includes: determining an intersection between the sample prediction palm part frame in the sample palm image and the palm part area in the infrared image; and cropping out a sample prediction palm part image from the sample palm image based on the intersection.

In this embodiment, the palm recognition device is further equipped with an infrared camera. The palm recognition device obtains an infrared image corresponding to the same physical palm. The palm recognition device performs area recognition on the infrared image, to determine a palm part area in the infrared image. The infrared image is an image obtained by the infrared camera imaging, based on infrared light, the palm.

In some embodiments, the recognizing a palm part area from the infrared image includes: detecting a finger gap point in the infrared image; and determining the palm part area in the infrared image based on the finger gap point.

For example, the palm recognition device performs detection on the finger gap point in the infrared image, and determines the palm part area in the infrared image based on the finger gap point.

FIG. 6 is a schematic diagram of a finger gap point in a palm. The finger gap point is a first finger gap point 601 between an index finger and a middle finger, or the finger gap point is a second finger gap point 602 between the middle finger and a ring finger, or the finger gap point is a third finger gap point 603 between the ring finger and a little finger.

Because a palm part area in a sample palm image may exist in any area in the sample palm image, to determine a position of the palm part area in the sample palm image, finger gap point detection is performed on the sample palm image, to obtain at least one finger gap point in the sample palm image, so that the palm part area can be determined subsequently according to the at least one finger gap point.

Operation 1305: Crop out a sample prediction palm part image from the sample palm image based on the sample prediction palm part frame.

The sample prediction palm part image is an effective recognition area predicted in the sample palm image, or the sample prediction palm part image is an area in the sample palm image in which the predicted palm part is located, or the sample prediction palm part image is an area in the sample palm image that is predicted and that can be configured for recognition.

In some embodiments, the palm recognition device obtains at least three finger gap points in the infrared image; the finger gap points are sequentially connected, to obtain a finger gap point connecting line; and the palm recognition device crops the infrared image based on the finger gap point connecting line to obtain the palm part area.

In some embodiments, the determining an intersection between the sample prediction palm part frame in the sample palm image and the palm part area in the infrared image includes: obtaining a coordinate parameter of the sample prediction palm part frame in the sample palm image, and obtaining a coordinate parameter of the palm part area in the infrared image; and determining an intersection between the sample prediction palm part frame and the palm part area based on the coordinate parameter of the sample prediction palm part frame and the coordinate parameter of the palm part area.

The palm recognition device obtains a coordinate parameter of the sample prediction palm part frame in the sample palm image, and obtains a coordinate parameter of the palm part area in the infrared image; and the palm recognition device crops, based on the intersection between the coordinate parameter of the sample prediction palm part frame and the coordinate parameter of the palm part area, the sample palm image to obtain the sample prediction palm part image corresponding to the palm part.

Operation 1306: Calculate a loss function value according to the sample palm part image and the sample prediction palm part image.

For example, the palm recognition device calculates the loss function value based on the sample palm part image and the sample prediction palm part image.

Operation 1307: Update a model parameter of the palm part detection model based on the loss function value.

Updating of the model parameter refers to updating a network parameter in the palm part detection model, or updating a network parameter of each network module in the model, or updating a network parameter of each network layer in the model, but is not limited thereto. This is not limited in the embodiments of this application.

The model parameter of the palm part detection model includes at least one of a network parameter of a backbone network, a network parameter of a neck network, and a network parameter of a prediction network.

In some embodiments, updating the model parameter of the palm part detection model includes updating network parameters of all network modules in the palm part detection model, or fixing network parameters of some network modules in the palm part detection model, and updating only network parameters of the remaining part of network modules. For example, when the model parameter of the palm part detection model is updated, the network parameter of the backbone network in the palm part detection model is fixed, and only the network parameter of the neck network and the network parameter of the prediction network are updated.

The network parameter of the backbone network, the network parameter of the neck network, and the network parameter of the prediction network in the palm part detection model are updated based on the loss function value by using the loss function value as a training indicator until the loss function value converges, to obtain the palm part detection model whose training is completed.

That the loss function value converges refers to at least one of the following cases: The loss function value no longer changes, or an error difference between two adjacent iterations during training of the palm part detection model is less than a preset value, or a quantity of times of training of the palm part detection model reaches a preset quantity of times, but is not limited thereto. This is not limited in the embodiments of this application.

In some embodiments, a target condition satisfied by the training may be that a quantity of times of iterations of training of an initial model reaches a target quantity of times. A technician may preset the quantity of times of iterations of training. Alternatively, the target condition satisfied by the training may be that the loss value satisfies a target threshold condition, but is not limited thereto. This is not limited in the embodiments of this application.

In summary, according to the method provided in this embodiment, the sample image features at the plurality of scales corresponding to the sample palm image are obtained by performing feature extraction on the sample palm image; feature fusion is performed on the sample image features at the plurality of scales, to obtain the sample image fusion feature; prediction is performed based on the sample image fusion feature, to obtain the sample prediction palm part frame identifying the palm part in the sample palm image; the sample palm image is cropped based on the sample prediction palm part frame to obtain the sample prediction palm part image corresponding to the palm part; a loss function value is calculated based on the sample palm part image and the sample prediction palm part image; and the model parameter of the palm part detection model is updated based on the loss function value, so that the trained palm part detection model can have higher prediction accuracy of the palm part frame, to obtain a more accurate palm part frame.

For example, application scenarios of the palm image processing method provided in the embodiments of this application include but are not limited to the following scenarios.

For example, in a palm image recognition payment scenario:

A palm recognition device of a merchant captures a physical palm of a user, to obtain a palm image of the user, determines a target user identifier of the palm image by using the palm image processing method provided in the embodiments of this application, and transfers some resources in a resource account corresponding to the target user identifier to a merchant resource account, to implement automatic payment through the palm part.

For another example, in a cross-device payment scenario:

A user may complete identity registration at home or another private space by using a personal mobile phone, and bind an account of the user to a palm image of the user. Then the palm image of the user may be recognized on an in-store device, to determine the account of the user, and the user directly performs payment through the account.

For another example, in a check scenario at work:

A palm recognition device obtains a palm image of a user by capturing a physical palm of the user. The palm image processing method provided in the embodiments of this application is used, so that a target user identifier of the palm image is determined, a check in label is established for the target user identifier, and it is determined that the target user identifier has completed check in at work at a current time point.

Certainly, in addition to being applied to the foregoing scenarios, the method provided in this embodiment of this application may be alternatively applied to other scenarios requiring palm image processing. A specific application scenario is not limited in the embodiments of this application.

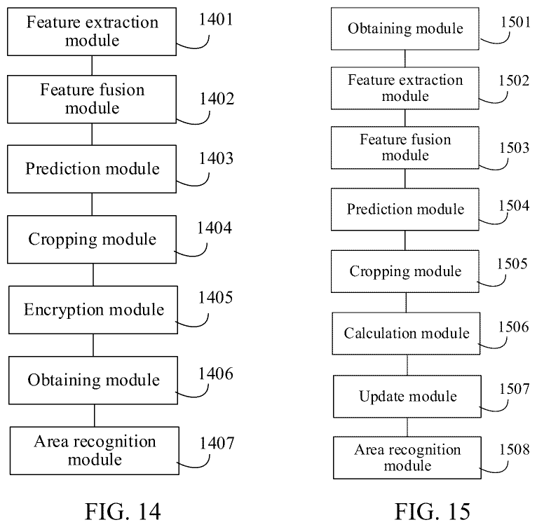

FIG. 14 is a schematic diagram of a structure of a palm image processing apparatus according to an exemplary embodiment of this application. The apparatus may be implemented as the entire or a part of a palm recognition device by using software, hardware, or a combination of thereof. The apparatus includes:
a feature extraction module 1401, configured to obtain a palm image, and perform feature extraction on the palm image, to obtain image features at a plurality of scales;
a feature fusion module 1402, configured to fuse the image features at the plurality of scales, to obtain an image fusion feature;
a prediction module 1403, configured to determine, based on the image fusion feature, a palm part frame identifying a palm part in the palm image;
a cropping module 1404, configured to crop out a palm part image from the palm image based on the palm part frame; and
an encryption module 1405, configured to perform image encryption on the palm part image, to obtain encrypted palm part image data, the encrypted palm part image data being configured for being transmitted to a server, and the server performing identity verification based on the encrypted palm part image data.

The feature extraction module 1401 may be a backbone network of the palm part detection model, the feature fusion module 1402 may be a neck network of the palm part detection model, the prediction module 1403 may be at least a part of a prediction network of the palm part detection model, and the cropping module 1404 may be a part of the prediction network, or may be an independent module in the palm part detection model, or may be an independent module outside the palm part detection model.

In some embodiments, the feature extraction module 1401 is the backbone network of the palm part detection model, and is configured to perform a slicing operation on the palm image, to obtain slice images at the plurality of scales; and respectively perform feature extraction on the slice images at the plurality of scales, to obtain the image features at the plurality of scales.

In some embodiments, the feature extraction module 1401 is the backbone network of the palm part detection model, and is configured to determine, based on the palm image, a slice image at a maximum scale in the plurality of scales; and use the slice image at the maximum scale as a first layer, and start downsampling layer by layer, to obtain the slice images at the plurality of scales including the slice image at the first layer.

In some embodiments, the feature extraction module 1401 is the backbone network of the palm part detection model, and is configured to downsample and splice, through the backbone network, pixels in the palm image at the plurality of scales, to obtain the slice images at the plurality of scales. There are two adjacent pixels in slice images at different scales, and a quantity of pixels between the two pixels at which sampling occurs in the palm image is different.

In some embodiments, the feature fusion module 1402 is the neck network of the palm part detection model, and is configured to perform, through the neck network, feature fusion on the image features at the plurality of scales, to obtain the image fusion feature.

In some embodiments, the feature fusion module 1402 is the neck network of the palm part detection model, and is configured to perform feature fusion based on the image features at the plurality of scales, to obtain first intermediate features at the plurality of scales; perform feature fusion at the plurality of scales based on the first intermediate features at the plurality of scales, to obtain second intermediate features at the plurality of scales; and perform feature fusion on the second intermediate features at the plurality of scales, to obtain the image fusion feature.

In some embodiments, the plurality of scales are N scales, N is a positive integer greater than 1, and the feature fusion module 1402 is the neck network of the palm part detection model, and is configured to determine, based on an image feature ranking first in a positive order of scale, a first intermediate feature ranking first in the positive order of scale; upsample layer by layer starting from the first intermediate feature ranking first in the positive order of scale, and fuse a result of upsampling a first intermediate feature ranking n^{th} in the positive order of scale with an image feature ranking (n+1)^{th} in the positive order of scale, to obtain a first intermediate feature ranking (n+1)^{th} in the positive order of scale, where n is a positive integer from 1 to N−1; and the positive order of scale is in ascending order of scale; and determine, when obtaining a first intermediate feature at an N^{th} layer, the first intermediate features at the plurality of scales from a first layer to the N^{th} layer.

In some embodiments, the plurality of scales are N scales, N is a positive integer greater than 1, and the feature fusion module 1402 is the neck network of the palm part detection model, and is configured to determine, based on a first intermediate feature ranking first in a reverse order of scale, a second intermediate feature ranking first in the reverse order of scale; downsample layer by layer starting from the second intermediate feature ranking first in the reverse order of scale, and fuse a result of downsampling a second intermediate feature ranking m^{th} in the reverse order of scale with a first intermediate feature ranking (m+1)^{th} in the reverse order of scale, to obtain a second intermediate feature ranking (n+1)^{th} in the reverse order of scale, where m is an integer from 1 to N−1; and the reverse order of scale is in descending order of scale; and determine, when obtaining the first intermediate feature at the N^{th} layer, the first intermediate features at the plurality of scales from the first layer to the N^{th} layer.

In some embodiments, the prediction module 1403 is at least a part of the prediction network of the palm part detection model, and is configured to perform grid division on the image fusion feature, to obtain a plurality of grid features of the image fusion feature; and perform prediction based on the plurality of grid features, to obtain the palm part frame.

In some embodiments, the palm recognition device is equipped with an infrared camera, and the obtaining module 1406 is configured to obtain an infrared image collected of a palm part the same as the palm image, where the infrared image is an image obtained by the infrared camera imaging, based on infrared light, the palm part.

The area recognition module 1407 is configured to recognize a palm part area from the infrared image.

In some embodiments, the cropping module 1404 is configured to determine an intersection between the palm part frame in the palm image and the palm part area in the infrared image; and crop out the palm part image from the palm image based on the intersection.

In some embodiments, the area recognition module 1407 is configured to detect a finger gap point in the infrared image; and determine the palm part area in the infrared image based on the finger gap point.

In some embodiments, the area recognition module 1407 is configured to obtain at least three finger gap points in the infrared image; sequentially connect the finger gap points, to obtain a finger gap point connecting line; and crop the infrared image based on the finger gap point connecting line to obtain the palm part area.

In some embodiments, the cropping module 1404 is configured to obtain a coordinate parameter of the palm part frame in the palm image, and obtain a coordinate parameter of the palm part area in the infrared image; and determine the intersection between the palm part frame and the palm part area based on the coordinate parameter of the palm part frame and the coordinate parameter of the palm part area.

FIG. 15 is a schematic diagram of a structure of an apparatus for training a palm part detection model according to an exemplary embodiment of this application. The apparatus may be implemented as all or a part of a palm recognition device by using software, hardware, or a combination of the two. The apparatus includes a palm part detection model, an obtaining module 1501, a calculation module 1506, and an update module 1507. The palm part detection model includes a feature extraction module 1502, a feature fusion module 1503, and a prediction module 1504, and may further include a cropping module 1505. The feature extraction module 1502 may be a backbone network of the palm part detection model, the feature fusion module 1503 may be a neck network of the palm part detection model, the prediction module 1504 may be at least a part of a prediction network, and the cropping module 1505 may be a part of the prediction network, or may be an independent module in the palm part detection model, or may be an independent module outside the palm part detection model.

The obtaining module 1501 is configured to obtain a sample palm image and a sample palm part image;

The feature extraction module 1502 is configured to perform feature extraction on the sample palm image, to obtain sample image features at a plurality of scales;

The feature fusion module 1503 is configured to fuse the sample image features at the plurality of scales, to obtain a sample image fusion feature;

The prediction module 1504 is configured to determine, based on the sample image fusion feature, a sample prediction palm part frame identifying a palm part in the sample palm image;

The cropping module 1505 is configured to crop out a sample prediction palm part image from the sample palm image based on the sample prediction palm part frame;

The calculation module 1506 is configured to calculate a loss function value according to the sample palm part image and the sample prediction palm part image.

The update module 1507 is configured to update a model parameter of the palm part detection model based on the loss function value.

In some embodiments, the feature extraction module 1502 is the backbone network of the palm part detection model, and is configured to perform a slicing operation on the sample palm image, to obtain slice images at the plurality of scales; and respectively perform feature extraction on the slice images at the plurality of scales, to obtain the sample image features at the plurality of scales.

In some embodiments, the feature extraction module 1502 is the backbone network of the palm part detection model, and is configured to determine, based on the sample palm image, a slice image at a maximum scale in the plurality of scales; and use the slice image at the maximum scale as a first layer, and start downsampling layer by layer, to obtain the slice images at the plurality of scales including the slice image at the first layer.

In some embodiments, the feature extraction module 1502 is the backbone network of the palm part detection model, and is configured to sample and splice pixels in the sample palm image at the plurality of scales, to obtain the slice images at the plurality of scales. There are two adjacent pixels in slice images at different scales, and a quantity of pixels between the two pixels at which sampling occurs in the sample palm image is different.

In some embodiments, the feature fusion module 1503 is the neck network of the palm part detection model, and is configured to perform feature fusion on the sample image features at the plurality of scales, to obtain the sample image fusion feature.

In some embodiments, the feature fusion module 1503 is the neck network of the palm part detection model, and is configured to input the sample image features at the plurality of scales into the neck network; perform feature fusion based on the sample image features at the plurality of scales, to obtain first intermediate features at the plurality of scales; perform feature fusion at the plurality of scales based on the first intermediate features at the plurality of scales, to obtain second intermediate features at the plurality of scales; and perform feature fusion on the second intermediate features at the plurality of scales, to obtain the sample image fusion feature.

In some embodiments, the plurality of scales are N scales, N is a positive integer greater than 1, and the feature fusion module 1503 is the neck network of the palm part detection model, and is configured to determine, based on a sample image feature ranking first in a positive order of scale, a first intermediate feature ranking first in the positive order of scale; upsample layer by layer starting from the first intermediate feature ranking first in the positive order of scale, and fuse a result of upsampling a first intermediate feature ranking n^{th} in the positive order of scale with a sample image feature ranking (n+1)^{th} in the positive order of scale, to obtain a first intermediate feature ranking (n+1)^{th} in the positive order of scale, where n is a positive integer from 1 to N−1; and the positive order of scale is in ascending order of scale; and determine, when obtaining a first intermediate feature at an N^{th} layer, the first intermediate features at the plurality of scales from a first layer to the N^{th} layer.

In some embodiments, the plurality of scales are N scales, N is a positive integer greater than 1, and the feature fusion module 1503 is configured to determine, based on a first intermediate feature ranking first in a reverse order of scale, a second intermediate feature ranking first in the reverse order of scale; downsample layer by layer starting from the second intermediate feature ranking first in the reverse order of scale, and fuse a result of downsampling a second intermediate feature ranking m^{th} in the reverse order of scale with a first intermediate feature ranking (m+1)^{th} in the reverse order of scale, to obtain a second intermediate feature ranking (n+1)^{th} in the reverse order of scale, where m is an integer from 1 to N−1; and the reverse order of scale is in descending order of scale; and determine, when obtaining the first intermediate feature at the N^{th} layer, the first intermediate features at the plurality of scales from the first layer to the N^{th} layer.

In some embodiments, the prediction module 1504 is at least a part of the prediction network of the palm part detection model, and is configured to perform grid division on the sample image fusion feature, to obtain a plurality of grid features of the sample image fusion feature; and perform prediction on the plurality of grid features, to obtain the sample prediction palm part frame.

In some embodiments, the palm recognition device is equipped with an infrared camera, and the obtaining module 1501 is configured to obtain an infrared image collected of a palm part the same as the sample palm image, where the infrared image is an image obtained by the infrared camera imaging, based on infrared light, the palm part.

The area recognition module 1508 is configured to recognize a palm part area from the infrared image.

The cropping module 1505 is configured to determine an intersection between the sample prediction palm part frame in the sample palm image and the palm part area in the infrared image; and crop out a palm part image from the sample palm image based on the intersection.

In some embodiments, the area recognition module 1508 is configured to detect a finger gap point in the infrared image; and determine the palm part area in the infrared image based on the finger gap point.

In some embodiments, the cropping module 1505 is configured to obtain a coordinate parameter of the sample prediction palm part frame in the sample palm image, and obtain a coordinate parameter of the palm part area in the infrared image; and determine an intersection between the sample prediction palm part frame and the palm part area based on the coordinate parameter of the sample prediction palm part frame and the coordinate parameter of the palm part area.

In some embodiments, the area recognition module 1508 is configured to perform detection on the finger gap point in the infrared image, and determine the palm part area in the infrared image based on the finger gap point.

In some embodiments, the area recognition module 1508 is configured to obtain at least three finger gap points in the infrared image; sequentially connect the finger gap points, to obtain a finger gap point connecting line; and crop the infrared image based on the finger gap point connecting line to obtain the palm part area.

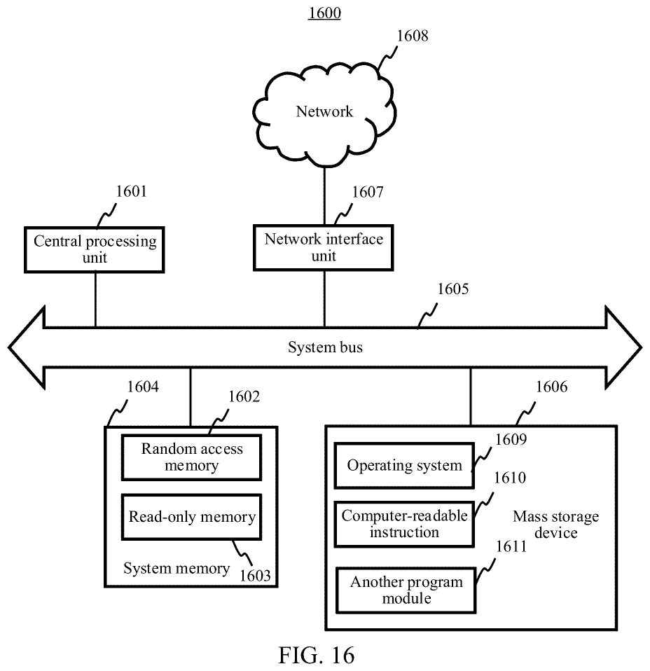

FIG. 16 is a structural block diagram of a computer device 1600 according to an exemplary embodiment of this application. The computer device can be implemented as the server in the foregoing solution of this application. The image computer device 1600 includes a central processing unit (CPU) 1601, a system memory 1604 including a random access memory (RAM) 1602 and a read-only memory (ROM) 1603, and a system bus 1605 connecting the system memory 1604 to the CPU 1601. The image computer device 1600 further includes a large-capacity storage device 1606 configured to store an operating system 1609, an application 1610 and another program module 1611.

The mass storage device 1606 is connected to the CPU 1601 by using a mass storage controller (not shown) connected to the system bus 1605. The large-capacity storage device 1606 and a computer-readable medium associated with the large-capacity storage device provide non-volatile storage to the image computer device 1600. In other words, the mass storage device 1606 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, an erasable programmable ROM (EPROM), an electrically-erasable programmable ROM (EEPROM), a flash memory or another solid-state memory technology, a CD-ROM, a digital versatile disc (DVD) or another optical memory, a magnetic cassette, a magnetic tape, a magnetic disk memory, or another magnetic storage device. Certainly, a person skilled in the art may know that the computer storage medium is not limited to the foregoing types. The system memory 1604 and the large-capacity storage device 1606 may be collectively referred to as a memory.

According to the embodiments of the present disclosure, the image computer device 1600 may be further connected, through a network such as the internet, to a remote computer on the network and run. That is, the image computer device 1600 may be connected to a network 1608 by using a network interface unit 1607 connected to the system bus 1605, or may be connected to another type of network or a remote computer system (not shown) by using a network interface unit 1607.

The memory further includes at least one piece of computer-readable instruction. The at least one piece of computer-readable instruction is stored in the memory. The central processing unit 1601 executes the at least one piece of computer-readable instruction to implement all or some of the operations in the palm image processing method shown in the foregoing embodiments or the method for training a palm part detection model.

The embodiments of this application further provide a computer device, the computer device includes a processor and a memory, the memory stores at least one program, and the at least one program is loaded and executed by the processor to implement the palm image processing method provided in the foregoing method embodiments or the method for training a palm part detection model.

The embodiments of this application further provide a non-transitory computer-readable storage medium, the storage medium having at least one computer-readable instruction stored therein, and the at least one computer-readable instruction being loaded and executed by a processor to implement the palm image processing method provided in the foregoing method embodiments or the method for training a palm part detection model.

The embodiments of this application further provide a computer program product, the computer program product including computer-readable instructions, and the computer-readable instructions being stored in a non-transitory computer-readable storage medium; and a processor of a computer device reading the computer-readable instructions from the computer-readable storage medium and executing the computer-readable instructions, to enable the computer device to implement the palm image processing method provided in the foregoing method embodiments or the method for training a palm part detection model.

In a specific implementation of this application, the related data, a palm image, historical data, and a portrait are user data processing-related data that is related to a user identity or user characteristics. When the embodiments of this application are applied to specific products or technologies, user permission or consent needs to be obtained, and the collection, use, and processing of related data comply with related laws, regulations, and standards of related countries and regions.

“Plurality of” mentioned in the specification means two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects.

A person of ordinary skill in the art may understand that all or some of the operations of the embodiments may be implemented by hardware or a program instructing related hardware. The program may be stored in a computer-readable storage medium. The storage medium may be a read-only memory, a magnetic disk, an optical disc, or the like.

Technical features of the foregoing embodiments may be combined in different manners to form other embodiments. For concise description, not all possible combinations of the technical features in the embodiment are described. However, provided that combinations of the technical features do not conflict with each other, the combinations of the technical features are considered as falling within the scope recorded in this specification.

The term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing embodiments only describe several implementations of this application, which are described specifically and in detail, but cannot be construed as a limitation to the patent scope of the present invention. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A palm image processing method performed by a computer device, the method comprising:
obtaining a palm image, and performing feature extraction on the palm image, to obtain image features at a plurality of scales;
fusing the image features at the plurality of scales, to obtain an image fusion feature;
determining, based on the image fusion feature, a frame identifying a palm part in the palm image as a palm part image;
performing image encryption on the palm part image to obtain encrypted palm part image data; and
transmitting the encrypted palm part image data to a server, wherein the server is configured for performing identity recognition based on the encrypted palm part image data.

2. The method according to claim 1, wherein the performing feature extraction on the palm image, to obtain image features at a plurality of scales comprises:
performing a slicing operation on the palm image through a backbone network, to obtain slice images at the plurality of scales; and
respectively performing feature extraction on the slice images at the plurality of scales through the backbone network, to obtain the image features at the plurality of scales.

3. The method according to claim 2, wherein the performing a slicing operation on the palm image through the backbone network, to obtain slice images at the plurality of scales comprises:
determining, through the backbone network and based on the palm image, a slice image at a maximum scale in the plurality of scales; and
using, through the backbone network, the slice image at the maximum scale as a first layer, and downsampling layer by layer, to obtain the slice images at the plurality of scales including the slice image at the first layer.

4. The method according to claim 2, wherein the performing a slicing operation on the palm image through the backbone network, to obtain slice images at the plurality of scales comprises:
downsampling and splicing, through the backbone network, pixels in the palm image at the plurality of scales, to obtain the slice images at the plurality of scales, wherein
there are two adjacent pixels in slice images at different scales, and a quantity of pixels between the two pixels at which sampling occurs in the palm image is different.

5. The method according to claim 1, wherein the fusing the image features at the plurality of scales, to obtain an image fusion feature comprises:
inputting the image features at the plurality of scales into a neck network for feature fusion, to obtain the image fusion feature.

6. The method according to claim 5, wherein the inputting the image features at the plurality of scales into the neck network for feature fusion, to obtain the image fusion feature comprises:
inputting the image features at the plurality of scales into the neck network;
performing, through the neck network, feature fusion based on the image features at the plurality of scales, to obtain first intermediate features at the plurality of scales;
performing, through the neck network, feature fusion at the plurality of scales based on the first intermediate features at the plurality of scales, to obtain second intermediate features at the plurality of scales; and
performing, through the neck network, feature fusion on the second intermediate features at the plurality of scales, to obtain the image fusion feature.

7. The method according to claim 6, wherein the plurality of scales are N scales, N is a positive integer greater than 1, and the performing, through the neck network, feature fusion based on the image features at the plurality of scales, to obtain first intermediate features at the plurality of scales comprises:
determining, based on an image feature ranking first in a positive order of scale, a first intermediate feature ranking first in the positive order of scale;
upsampling layer by layer starting from the first intermediate feature ranking first in the positive order of scale, and fusing a result of upsampling a first intermediate feature ranking n^{th} in the positive order of scale with an image feature ranking (n+1)^{th} in the positive order of scale, to obtain a first intermediate feature ranking (n+1)^{th} in the positive order of scale, wherein n is a positive integer from 1 to N−1; and the positive order of scale is in ascending order of scale; and
determining, when obtaining a first intermediate feature at an N^{th} layer, the first intermediate features at the plurality of scales from a first layer to the N^{th} layer.

8. The method according to claim 1, wherein the determining, based on the image fusion feature, a frame identifying a palm part in the palm image comprises:
performing grid division on the image fusion feature, to obtain a plurality of grid features of the image fusion feature; and
inputting the plurality of grid features into the prediction network, and performing prediction on the plurality of grid features, to obtain the palm part frame.

9. The method according to claim 1, wherein method further comprises:
obtaining an infrared image collected of a palm part the same as the palm image using an infrared camera;
detecting a finger gap point in the infrared image;
recognizing a palm part area from the infrared image based on the finger gap point;
determining an intersection between the palm part frame in the palm image and the palm part area in the infrared image; and
cropping out the palm part image from the palm image based on the intersection.

10. A computer device, comprising a processor and a memory, the memory storing at least one computer-readable instruction, the at least one computer-readable instruction, when loaded and executed by the processor, causing the computer device to implement a palm image processing method including:
obtaining a palm image, and performing feature extraction on the palm image, to obtain image features at a plurality of scales;
fusing the image features at the plurality of scales, to obtain an image fusion feature;
determining, based on the image fusion feature, a frame identifying a palm part in the palm image as a palm part image;
performing image encryption on the palm part image to obtain encrypted palm part image data; and
transmitting the encrypted palm part image data to a server, wherein the server is configured for performing identity recognition based on the encrypted palm part image data.

11. The computer device according to claim 10, wherein the performing feature extraction on the palm image, to obtain image features at a plurality of scales comprises:
performing a slicing operation on the palm image through a backbone network, to obtain slice images at the plurality of scales; and
respectively performing feature extraction on the slice images at the plurality of scales through the backbone network, to obtain the image features at the plurality of scales.

12. The computer device according to claim 11, wherein the performing a slicing operation on the palm image through the backbone network, to obtain slice images at the plurality of scales comprises:
determining, through the backbone network and based on the palm image, a slice image at a maximum scale in the plurality of scales; and
using, through the backbone network, the slice image at the maximum scale as a first layer, and downsampling layer by layer, to obtain the slice images at the plurality of scales including the slice image at the first layer.

13. The computer device according to claim 11, wherein the performing a slicing operation on the palm image through the backbone network, to obtain slice images at the plurality of scales comprises:
downsampling and splicing, through the backbone network, pixels in the palm image at the plurality of scales, to obtain the slice images at the plurality of scales, wherein
there are two adjacent pixels in slice images at different scales, and a quantity of pixels between the two pixels at which sampling occurs in the palm image is different.

14. The computer device according to claim 10, wherein the fusing the image features at the plurality of scales, to obtain an image fusion feature comprises:
inputting the image features at the plurality of scales into a neck network for feature fusion, to obtain the image fusion feature.

15. The computer device according to claim 14, wherein the inputting the image features at the plurality of scales into the neck network for feature fusion, to obtain the image fusion feature comprises:
inputting the image features at the plurality of scales into the neck network;
performing, through the neck network, feature fusion based on the image features at the plurality of scales, to obtain first intermediate features at the plurality of scales;
performing, through the neck network, feature fusion at the plurality of scales based on the first intermediate features at the plurality of scales, to obtain second intermediate features at the plurality of scales; and
performing, through the neck network, feature fusion on the second intermediate features at the plurality of scales, to obtain the image fusion feature.

16. The computer device according to claim 15, wherein the plurality of scales are N scales, N is a positive integer greater than 1, and the performing, through the neck network, feature fusion based on the image features at the plurality of scales, to obtain first intermediate features at the plurality of scales comprises:
determining, based on an image feature ranking first in a positive order of scale, a first intermediate feature ranking first in the positive order of scale;
upsampling layer by layer starting from the first intermediate feature ranking first in the positive order of scale, and fusing a result of upsampling a first intermediate feature ranking n^{th} in the positive order of scale with an image feature ranking (n+1)^{th} in the positive order of scale, to obtain a first intermediate feature ranking (n+1)^{th} in the positive order of scale, wherein n is a positive integer from 1 to N−1; and the positive order of scale is in ascending order of scale; and
determining, when obtaining a first intermediate feature at an N^{th} layer, the first intermediate features at the plurality of scales from a first layer to the N^{th} layer.

17. The computer device according to claim 10, wherein the determining, based on the image fusion feature, a frame identifying a palm part in the palm image comprises:
performing grid division on the image fusion feature, to obtain a plurality of grid features of the image fusion feature; and
inputting the plurality of grid features into the prediction network, and performing prediction on the plurality of grid features, to obtain the palm part frame.

18. The computer device according to claim 10, wherein the method further comprises:
obtaining an infrared image collected of a palm part the same as the palm image using an infrared camera;
detecting a finger gap point in the infrared image;
recognizing a palm part area from the infrared image based on the finger gap point;
determining an intersection between the palm part frame in the palm image and the palm part area in the infrared image; and
cropping out the palm part image from the palm image based on the intersection.

19. A non-transitory computer-readable storage medium storing at least one computer-readable instruction therein, the at least one computer-readable instruction, when loaded and executed by a processor of a computer device, causing the computer device to implement a palm image processing method including:
obtaining a palm image, and performing feature extraction on the palm image, to obtain image features at a plurality of scales;
fusing the image features at the plurality of scales, to obtain an image fusion feature;
determining, based on the image fusion feature, a frame identifying a palm part in the palm image as a palm part image;
performing image encryption on the palm part image to obtain encrypted palm part image data; and
transmitting the encrypted palm part image data to a server, wherein the server is configured for performing identity recognition based on the encrypted palm part image data.

20. The non-transitory computer-readable storage medium according to claim 19, wherein the method further comprises:
obtaining an infrared image collected of a palm part the same as the palm image using an infrared camera;
detecting a finger gap point in the infrared image;
recognizing a palm part area from the infrared image based on the finger gap point;
determining an intersection between the palm part frame in the palm image and the palm part area in the infrared image; and
cropping out the palm part image from the palm image based on the intersection.
